(19) United States
(12) Patent Application Publication
(10) Pub. No.: US 2012/0324903 A1
(43) Pub. Date: Dec. 27, 2012

(54) HIGH EFFICIENCY COMPACT GAS TURBINE ENGINE

(75) Inventors: David William Dewis, North Hampton, NH (US); James B. Kesseli, Greenland, NH (US); James S. Nash, North Hampton, NH (US); John D. Watson, Evergreen, CO (US); Thomas Wolf, Winchester, MA (US)

(73) Assignee: ICR TURBINE ENGINE CORPORATION, Hampton, NH (US)

(21) Appl. No.: 13/534,909

(22) Filed: Jun. 27, 2012

Related U.S. Application Data
(60) Provisional application No. 61/501,552, filed on Jun. 27, 2011.
(60) Provisional application No. 61/501,558, filed on Jun. 27, 2011.

(51) Int. Cl. F02C 6/00

(52) U.S. Cl. 60/772; 60/801

(57) ABSTRACT

This disclosure relates to a highly efficient gas turbine engine architecture utilizing multiple stages of intercooling and reheat, ceramic technology, turbocharger technology and high pressure combustion. The approach includes utilizing a conventional dry low NOx combustor for the main combustor and thermal reactors for the reheat apparatuses. In a first configuration, there are three separate turbo-compressor spools and a free power turbine spool. In a second configuration, there are three separate turbo-compressor spools but no free power spool. In a third configuration, all the compressors and turbines are on a single shaft. Each of these configurations can include two stages of intercooling, two stages of reheat and a recuperator to preheat the working fluid before it enters the main combustor.

### CROSS REFERENCE TO RELATED APPLICATION

The present application claims the benefits, under 35 U.S.C. §119(e), of U.S. Provisional Application Ser. No. 61/501,552 entitled “Advanced Cycle Gas Turbine Engine” filed on Jun. 27, 2011 and U.S. Provisional Application Ser. No. 61/501,558 entitled “High Efficiency Compact Gas Turbine Engine” filed on Jun. 27, 2011, both of which are incorporated herein by reference.

### FIELD

This disclosure relates generally to the field of vehicle propulsion and power generation and, more specifically, to a gas turbine engine architecture for high efficiency shaft power output.

### BACKGROUND

There is a growing requirement for alternate fuels for vehicle propulsion and power generation. These include fuels such as natural gas, bio-diesel, ethanol, butanol, hydrogen and the like. Means of utilizing fuels needs to be accomplished more efficiently and with substantially lower carbon dioxide emissions and other air pollutants such as NOxs.

The gas turbine or Brayton cycle power plant has demonstrated many attractive features which make it a candidate for advanced vehicular propulsion as well as power generation. Gas turbine engines have the advantage of being highly fuel flexible and fuel tolerant. Additionally, these engines burn fuel at a lower temperature than comparable reciprocating engines so produce substantially less NOx per mass of fuel burned.

A multi-spool intercooled, recuperated gas turbine system is particularly suited for use as a power plant for a vehicle, especially a truck, bus or other overland vehicle. However, it has broader applications and may be used in many different environments and applications, including as a stationary electric power module for distributed power generation. The efficiency of such a gas turbine engine can be improved and engine size further reduced by increasing the pressure and/or temperature developed in the combustor while still remaining well below the temperature threshold of significant NOx production. This can be done using a conventional metallic combustor or thermal reactor to extract energy from the fuel. As combustor temperature and/or pressure are raised, new requirements are generated for other components such as the recuperator and compressor-turbine spools.

Further gains in efficiency can be realized by adding reheater apparatuses and additional intercooling to a single intercooled and recuperated multi-spool engine such as described in U.S. patent application Ser. No. 12/115,134 filed May 5, 2008, entitled “Multi-Spool Intercooled Recuperated Gas Turbine”.

In the past, gas turbine engines incorporating intercooled reheat cycles have had serious technical challenges with conventional metallic reheat combustors downstream of the main combustor. These reheater difficulties include:
turn-down stability of the combustion process
unacceptable pressure drop due to high flow velocity and temperatures
requirement for high temperature combustor liners

Additional intercooling and reheat apparatuses between spools also increases engine size.

There therefore remains a need for more efficient gas turbine engines while retaining their low emission and compact size characteristics. This includes a need for alternate approaches to react a fuel in a reheater apparatus to take advantage of the higher thermal efficiency of a gas turbine engine architecture that employs multiple stages of intercooling and reheat. There also remains a need for means to control multi-spool engines.

### SUMMARY

These and other needs are addressed by the various embodiments and configurations of the present disclosure which are directed generally to gas turbine engine systems and specifically to increasing gas turbine engine thermal efficiency to levels approaching and exceeding 50% utilizing multiple stages of intercooling and reheat, ceramic technology, turbocharger technology and high pressure combustion. When these technologies and approaches are combined, the result is an engine that still retains the low emission characteristics and compact size characteristics desired.

In embodiments of the present disclosure, the above mentioned reheater difficulties are addressed using a gas turbine engine architecture employing one or more metallic combustors and multiple stages of intercooling and reheat. This architecture can include one or more of:
a dry low NOx (“DLN”) combustor for the main combustor; and
thermal reactors (also known as thermal oxidizers) for the reheat apparatuses

The thermal reactor can operate at a high inlet temperature which accelerates the reaction within a small matrix such as provided by a ceramic honeycomb thermal reactor, for example. This type of thermal reactor can be designed to have a low pressure drop, not to require a high-temperature liner and not to develop stability problems in turn-down.

As will be discussed, this approach to increasing engine efficiency by using thermal reactors for the reheaters is illustrated by the example of an engine architecture based on two intercoolers and two reheaters in addition to a recuperator and a main combustor, all of which can provide a highly efficient, relatively compact engine.

At least three configurations of this engine are envisioned. In a first configuration, there are three separate turbo-compressor spools and a free power turbine spool. In a second configuration, there are three separate turbo-compressor spools but no free power spool. In a third configuration, all the compressors and turbines are on a single shaft. Each of the first, second and third configurations include each of two or more stages of intercooling and reheat. The configurations include a recuperator to preheat the working fluid before it enters the main combustor. The configurations may utilize a regenerator in place of the recuperator, especially for designs capable of developing higher peak operating temperatures.

The enabling ceramic and turbocharger technologies can allow a compact engine to be built such that the gas turbine engine cycle begins to close the efficiency gap between a practical gas turbine engine cycle and the maximum possible thermal efficiency of an ideal Carnot cycle. This may be accomplished by employing two intercoolers and two reheaters in addition to a main combustor and recuperator in a three or four spool engine. As is well known, the Carnot cycle is the most efficient thermodynamic cycle between two temperatures though it is impossible to achieve and difficult to even approximate in a practical engine. In the present disclosure, the combustor may be a conventional metallic combustor and the two reheaters may be thermal reactors. As can be appreciated, the combustor may also be a thermal reactor and one or both of the reheaters may be metallic combustors. This engine configuration has the potential to approach 60% thermal efficiency for a peak combustor output temperature that would yield about 80% efficiency in an ideal Carnot cycle.

It is well-known that there is an optimum gas turbine engine pressure ratio for maximum thermal efficiency. However, as the pressure ratio is increased beyond this optimum, thermal efficiency decreases slowly while engine size decreases rapidly. Thus a more compact engine with relatively high thermal efficiency is enabled by a gas turbine engine pressure ratio that is significantly higher than the optimum pressure ratio based on optimizing thermal efficiency alone. This design approach is described in “Preliminary Design and Projected Performance for Intercooled Recuperated Microturbine”, James B. Kesseli, Thomas L. Wolf, James S. Nash, Proceedings of the ASME TurboExpo 2008 Microturbine and Small Turbomachinery Systems, Jun. 9-13, 2008, Berlin, Germany.

In a first embodiment, an engine is disclosed comprising: a higher pressure spool having a higher pressure compressor and a higher pressure turbine; an intermediate pressure spool having an intermediate pressure compressor and an intermediate pressure turbine; a lower pressure spool having a lower pressure compressor and a lower pressure turbine; wherein at least one of the following is true: (i) first and second intercoolers are positioned respectively between the lower and intermediate pressure compressors and the intermediate and higher pressure compressors, whereby the first intercooler removes thermal energy from a first compressor output of the lower pressure compressor and the second intercooler removes thermal energy from a second compressor output of the intermediate pressure compressor; and (ii) first and second thermal reactors are positioned respectively between the higher and intermediate pressure turbines and the intermediate and lower pressure turbines, whereby the first thermal reactor adds thermal energy to a first turbine output of the higher pressure turbine and the second thermal reactor adds thermal energy to a second turbine output of the intermediate pressure turbine.

A method is disclosed comprising: compressing, by a lower pressure compressor, a working fluid to form a lower pressure compressor working fluid; compressing, by an intermediate pressure compressor, the lower pressure compressor working fluid to form an intermediate pressure compressor working fluid, an operating pressure of the lower pressure compressor working fluid being less than an operating pressure of the intermediate pressure compressor working fluid; compressing, by a higher pressure compressor, the intermediate pressure compressor working fluid to form a higher pressure compressor working fluid, an operating pressure of the intermediate pressure compressor working fluid being less than an operating pressure of the higher pressure compressor working fluid; combusting, by a combustor, the third working fluid in the presence of a fuel to form a combustor output; operating, by the combustor output, a higher pressure turbine to form a higher pressure turbine output; operating, by the higher pressure turbine output, an intermediate pressure turbine to form an intermediate pressure turbine output; and operating, by the intermediate pressure turbine output, a lower pressure turbine to form an engine output; wherein at least one of the following is true: (i) first and second intercoolers are positioned respectively between the lower and intermediate pressure compressors and the intermediate and higher pressure compressors, whereby the first intercooler removes thermal energy from lower pressure compressor output and the second intercooler removes thermal energy from the intermediate compressor output; and (ii) first and second thermal reactors are positioned respectively between the higher and intermediate pressure turbines and the intermediate and lower pressure turbines, whereby the first thermal reactor adds thermal energy to higher pressure turbine output and the second thermal reactor adds thermal energy to the intermediate pressure turbine output.

In a second embodiment, an engine is disclosed comprising: a higher pressure spool having a higher pressure compressor, a higher pressure turbine, and a first rotatable shaft rotatably couples the higher pressure compressor and the higher pressure turbine; an intermediate pressure spool having an intermediate pressure compressor, an intermediate pressure turbine, and a second shaft rotatably couples the intermediate pressure compressor and intermediate pressure turbine; a lower pressure spool having a lower pressure compressor, a lower pressure turbine, and a third shaft rotatably couples the lower pressure compressor and lower pressure turbine; wherein at least two of the higher, intermediate, and lower pressure spools are in mechanical communication with one or both of a motor/generator device; and wherein at least one of the following is true: (i) first and second intercoolers are positioned respectively between the lower and intermediate pressure compressors and the intermediate and higher pressure compressors, whereby the first intercooler removes thermal energy from a first compressor output of the lower pressure compressor and the second intercooler removes thermal energy from a second compressor output of the intermediate pressure compressor; and (ii) first and second thermal reactors are positioned respectively between the higher and intermediate pressure turbines and the intermediate and lower pressure turbines, whereby the first thermal reactor adds thermal energy to a first turbine output of the higher pressure turbine and the second thermal reactor adds thermal energy to a second turbine output of the intermediate pressure turbine.

Another method is disclosed comprising providing: a higher pressure spool having a higher pressure compressor, a higher pressure turbine, and a first rotatable shaft rotatably couples the higher pressure compressor and the higher pressure turbine; an intermediate pressure spool having an intermediate pressure compressor, an intermediate pressure turbine, and a second shaft rotatably couples the intermediate pressure compressor and intermediate pressure turbine; a lower pressure spool having a lower pressure compressor, a lower pressure turbine, and a third shaft rotatably couples the lower pressure compressor and lower pressure turbine; wherein at least two of the higher, intermediate, and lower pressure spools are in mechanical communication with one or both of a motor/generator device; compressing, by the lower pressure compressor, a working fluid to form a lower pressure compressor working fluid; compressing, by the intermediate pressure compressor, the lower pressure compressor working fluid to form an intermediate pressure compressor working fluid, an operating pressure of the lower pressure compressor working fluid being less than an operating pressure of the intermediate pressure compressor working fluid; compressing, by the higher pressure compressor, the intermediate pressure compressor working fluid to form a higher pressure compressor working fluid, an operating pressure of the intermediate pressure compressor working fluid being less than an operating pressure of the higher pressure compressor working fluid; combusting, by a combustor, the third working fluid in the presence of a fuel to form a combustor output; operating, by the combustor output, the higher pressure turbine to form a higher pressure turbine output; operating, by the higher pressure turbine output, the intermediate pressure turbine to form an intermediate pressure turbine output; and operating, by the intermediate pressure turbine output, the lower pressure turbine to form an engine output; wherein at least one of the following is true: (i) first and second intercoolers are positioned respectively between the lower and intermediate pressure compressors and the intermediate and higher pressure compressors, whereby the first intercooler removes thermal energy from lower pressure compressor output and the second intercooler removes thermal energy from the intermediate compressor output; and (ii) first and second thermal reactors are positioned respectively between the higher and intermediate pressure turbines and the intermediate and lower pressure turbines, whereby the first thermal reactor adds thermal energy to higher pressure turbine output and the second thermal reactor adds thermal energy to the intermediate pressure turbine output.

Also provided in all the above embodiments are systems and/or means for controlling:
starting the engine
providing a momentary power boost when required
providing engine braking when needed
providing over-speed protection for the free power turbine when the load is rapidly reduced or disconnected
charging the energy storage system
providing auxiliary power
controlling the responsiveness of the engine under at least one of changing load and ambient air conditions
restoring the compressors and/or turbines toward the operating line when surge or choking limits are approached
assisting the engine shut-down cycle
controlling the turbine inlet temperatures by extracting power during power down
controlling the recuperator hot side temperature by extracting power during power down.

The following definitions are used herein:

The phrases at least one, one or more, and/or are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The term automatic and variations thereof refers to any process or operation done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material”.

A bellows is a flexible or deformable, expandable and/or contractable, container or enclosure. A bellows is typically a container which is deformable in such a way as to alter its volume. A bellows can refer to a device for delivering pressurized air in a controlled quantity to a controlled location.

The Brayton cycle is a thermodynamic cycle that describes the workings of the gas turbine engine. It is named after George Brayton, the American engineer who developed it. It is also sometimes known as the Joule cycle. The ideal Brayton cycle consists of an isentropic compression process followed by an isobaric combustion process where fuel is burned, then an isentropic expansion process where the energized fluid gives up its energy to operate compressors or produce engine power and lastly an isobaric process where low grade heat is rejected to the atmosphere. An actual Brayton cycle consists of an adiabatic compression process followed by an isobaric combustion process where fuel is burned, then an adiabatic expansion process where the energized fluid gives up its energy to operate compressors or produce engine power and lastly an isobaric process where low grade heat is rejected to the atmosphere. The Carnot cycle is a particular thermodynamic cycle and is the most efficient existing cycle capable of converting a given amount of thermal energy into work. In the process of going through this cycle, the system may perform work, thereby acting as a heat engine. A system undergoing a Carnot cycle is called a Carnot heat engine, although such a ‘perfect’ engine is only theoretical and cannot be built in practice. Maximum efficiency is achieved if and only if no new entropy is created in the cycle. In reality it is not possible to build a thermodynamically reversible engine, so all real heat engines are less efficient than a Carnot engine. Nevertheless, the efficiency of a Carnot engine is useful for determining the maximum efficiency that could ever be expected for a given set of thermal reservoirs. The Carnot cycle is an idealization, since no real engine processes are reversible and all real physical processes involve some increase in entropy.

A ceramic is an inorganic, nonmetallic solid prepared by the action of heating and cooling. Ceramic materials may have a crystalline or partly crystalline structure, or may be amorphous (e.g., a glass).

The term computer-readable medium refers to any storage and/or transmission medium that participate in providing instructions to a processor for execution. Such a medium is commonly tangible and non-transient and can take many forms, including but not limited to, non-volatile media, volatile media, and transmission media and includes without limitation random access memory (“RAM”), read only memory (“ROM”), and the like. Non-volatile media includes, for example, NVRAM, or magnetic or optical disks. Volatile media includes dynamic memory, such as main memory. Common forms of computer-readable media include, for example, a floppy disk (including without limitation a Bernoulli cartridge, ZIP drive, and JAZ drive), a flexible disk, hard disk, magnetic tape or cassettes, or any other magnetic medium, magneto-optical medium, a digital video disk (such as CD-ROM), any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored. Computer-readable storage medium commonly excludes transient storage media, particularly electrical, magnetic, electromagnetic, optical, magneto-optical signals.

The terms determine, calculate and compute and variations thereof are used interchangeably and include any type of methodology, process, mathematical operation or technique.

An engine is a prime mover and refers to any device that uses energy to develop mechanical power, such as motion in some other machine. Examples are diesel engines, gas turbine engines, microturbines, Stirling engines and spark ignition engines.

A free power turbine as used herein is a turbine which is driven by a gas flow and whose rotary power is the principal mechanical output power shaft. A free power turbine is not connected to a compressor in the gasifier section, although the free power turbine may be in the gasifier section of the gas turbine engine. A power turbine may also be connected to a compressor in the gasifier section in addition to providing rotary power to an output power shaft.

A gas turbine engine as used herein may also be referred to as a turbine engine or microturbine engine. A microturbine is commonly a sub category under the class of prime movers called gas turbines and is typically a gas turbine with an output power in the approximate range of about a few kilowatts to about 700 kilowatts. A turbine or gas turbine engine is commonly used to describe engines with output power in the range above about 700 kilowatts. As can be appreciated, a gas turbine engine can be a microturbine since the engines may be similar in architecture but differing in output power level. The power level at which a microturbine becomes a turbine engine is arbitrary and the distinction has no meaning as used herein.

A gasifier is a turbine-driven compressor in a gas turbine engine dedicated to compressing air that, once heated, is expanded through a free power turbine to produce.

A prime power source refers to any device that uses energy to develop mechanical or electrical power, such as motion in some other machine. Examples are diesel engines, gas turbine engines, microturbines, Stirling engines, spark ignition engines and fuel cells.

A heat exchanger is a device that allows heat energy from a hotter fluid to be transferred to a cooler fluid without the hotter fluid and cooler fluid coming in contact. The two fluids are typically separated from each other by a solid material such as a metal that has a high thermal conductivity.

The term means shall be given its broadest possible interpretation in accordance with 35 U.S.C., Section 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary of the disclosure, brief description of the drawings, detailed description, abstract, and claims themselves.

A metallic material is a material containing a metal or a metallic compound. A metal refers commonly to alkali metals, alkaline-earth metals, radioactive and non-radioactive rare earth metals, transition metals, and other metals.

The no-failure regime of a ceramic material, as used herein, refers to the region of a flexural strength versus temperature graph for ceramic materials wherein both the flexural stress and temperature are low enough that the ceramic material has a very low probability of failure and has a lifetime of a very large number of flexural and/or thermal cycles. Operation of the ceramic material in the no failure regime means that the combination of maximum flexural stress and maximum temperature do not approach a failure limit such as the Weibull strength variability regime, the fast fracture regime, the slow crack growth regime or the creep fracture regime as illustrated in FIG. 3. When the ceramic material approaches or enters any of these failure regimes, then the probability of failure is increased precipitously and the lifetime to failure of the component is reduced precipitously. This applies to ceramic components that are manufactured within their design specifications from ceramic materials that are also within their design specifications. Typically, the no-failure regime of the ceramics used herein exists at operating temperatures of no more than about 1,550° K, more typically of no more than about 1,500° K, and even more typically of no more than about 1,400° K. Common maximum flexural strengths for the no-failure regime of the ceramics used herein are about 250 MPa and more commonly about 175 MPa.

Power density as used herein is power per unit volume (watts per cubic meter).

A recuperator is a heat exchanger dedicated to returning exhaust heat energy from a process back into the process to increase process efficiency. In a gas turbine thermodynamic cycle, heat energy is transferred from the turbine discharge to the combustor inlet gas stream, thereby reducing heating required by fuel to achieve a requisite firing temperature.

A regenerator is a type of heat exchanger where the flow through the heat exchanger is cyclical and periodically changes direction. It is similar to a countercurrent heat exchanger. However, a regenerator mixes a portion of the two fluid flows while a countercurrent exchanger maintains them separated. The exhaust gas trapped in the regenerator is mixed with the trapped air later. It is the trapped gases that get mixed, not the flowing gases, unless there are leaks past the valves.

Regenerative braking is the same as dynamic braking except the electrical energy generated is captured in an energy storage system for future use.

Specific power as used herein is power per unit mass (watts per kilogram).

Spool refers to a group of turbo machinery components on a common shaft.

Spool speed as used herein means spool shaft rotational speed which is typically expressed in revolutions per minute (“rpms”). As used herein, spool rpms and spool speed may be used interchangeably.

A thermal energy storage module is a device that includes either a metallic heat storage element or a ceramic heat storage element with embedded electrically conductive wires. A thermal energy storage module is similar to a heat storage block but is typically smaller in size and energy storage capacity.

A thermal oxidizer is a type of combustor comprised of a matrix material which is typically a ceramic and a large number of channels which are typically circular in cross section. When a fuel-air mixture is passed through the thermal oxidizer, it begins to react as it flows along the channels until it is fully reacted when it exits the thermal oxidizer. A thermal oxidizer is characterized by a smooth combustion process as the flow down the channels is effectively one-dimensional fully developed flow with a marked absence of hot spots.

A thermal reactor, as used herein, is another name for a thermal oxidizer.

A turbine is a rotary machine in which mechanical work is continuously extracted from a moving fluid by expanding the fluid from a higher pressure to a lower pressure. The simplest turbines have one moving part, a rotor assembly, which is a shaft or drum with blades attached. Moving fluid acts on the blades, or the blades react to the flow, so that they move and impart rotational energy to the rotor.

Turbine Inlet Temperature (TIT) as used herein refers to the gas temperature at the outlet of the combustor which is closely connected to the inlet of the high pressure turbine and these are generally taken to be the same temperature.

Turbocharger-like architecture or turbocharger technology means spools which are derived from modified stock turbocharger hardware components. In an engine where a centrifugal turbine with a ceramic rotor is used, the tip speed of the rotor is held to a proven allowable low limit (<500 m/s). Centrifugal compressors and turbines are sometimes called radial compressors and turbines.

A turbo-compressor spool assembly as used herein refers to an assembly typically comprised of an outer case, a radial compressor, a radial turbine wherein the radial compressor and radial turbine are attached to a common shaft. The assembly also includes inlet ducting for the compressor, a compressor rotor, a diffuser for the compressor outlet, a volute for incoming flow to the turbine, a turbine rotor and an outlet diffuser for the turbine. The shaft connecting the compressor and turbine includes a bearing system.

A volute is a scroll transition duct which looks like a tuba or a snail shell. Volutes may be used to channel flow gases from one component of a gas turbine to the next. Gases flow through the helical body of the scroll and are redirected into the next component. A key advantage of the scroll is that the device inherently provides a constant flow angle at the inlet and outlet. To date, this type of transition duct has only been successfully used on small engines or turbochargers where the geometrical fabrication issues are less involved.

### BRIEF DESCRIPTION OF THE DRAWINGS

The present disclosure may take form in various components and arrangements of components, and in various steps and arrangements of steps. The drawings are only for purposes of illustrating the preferred embodiments and are not to be construed as limiting the disclosure. In the drawings, like reference numerals refer to like or analogous components throughout the several views.

FIG. 1 is prior art schematic of the component architecture of a multi-spool gas turbine engine.

FIG. 2 illustrates the actual Brayton cycle for an intercooled, recuperated engine in a plot of pressure versus temperature. This is prior art.

FIG. 3 illustrates engine thermal efficiency versus shaft output power for the engine of FIG. 1. This is prior art.

FIG. 4 is a line drawing of a gas turbine engine suitable for long haul trucks. This is prior art.

FIG. 5 illustrates a plot of overall engine efficiency versus overall engine pressure ratio for an intercooled, recuperator engine architecture.

FIG. 6 shows a spool with a metallic compressor rotor and a ceramic turbine rotor. This is prior art.

FIG. 7 is schematic of a gas turbine compressor/turbine spool comprising a ceramic volute and shroud.

FIG. 8 is an isometric view of various gas turbine engine components.

FIG. 9 shows a schematic view of a thermal reactor. This is prior art.

FIG. 10 shows an architecture for an intercooled, recuperated gas turbine with multiple heat rejections and additions utilizing three separate turbo-compressor spools and a free power turbine spool.

FIG. 11 shows an architecture for an intercooled, recuperated gas turbine with multiple heat rejections and additions utilizing three separate turbo-compressor spools.

FIG. 12 shows an alternate architecture for an intercooled, recuperated gas turbine with multiple heat rejections and additions with all the compressors and turbines on a single shaft.

FIGS. 13A-B illustrate the form of a Brayton cycle for two intercooled, recuperated multi-spool engine architectures, pressure versus temperature.

FIG. 14 is a plot of engine shaft efficiency versus turbine inlet temperature for various engine architectures.

FIG. 15 illustrates integrated spool motor/generator for a high-efficiency multi-spool engine configuration with two stages of intercooling and reheat.

FIG. 16 shows a schematic of a computer control system for a multi-spool engine with two stages of intercooling and reheat.

FIG. 17 is a flow chart illustrating an operational embodiment of the system of FIG. 16.

FIG. 18 is a flow chart illustrating operator inputs to a computer controlled engine.

FIG. 19 is a flow chart illustrating automated procedures by a computer controlled engine.

### DETAILED DESCRIPTION

### Prior Art Multi-Spool Gas Turbine Engine

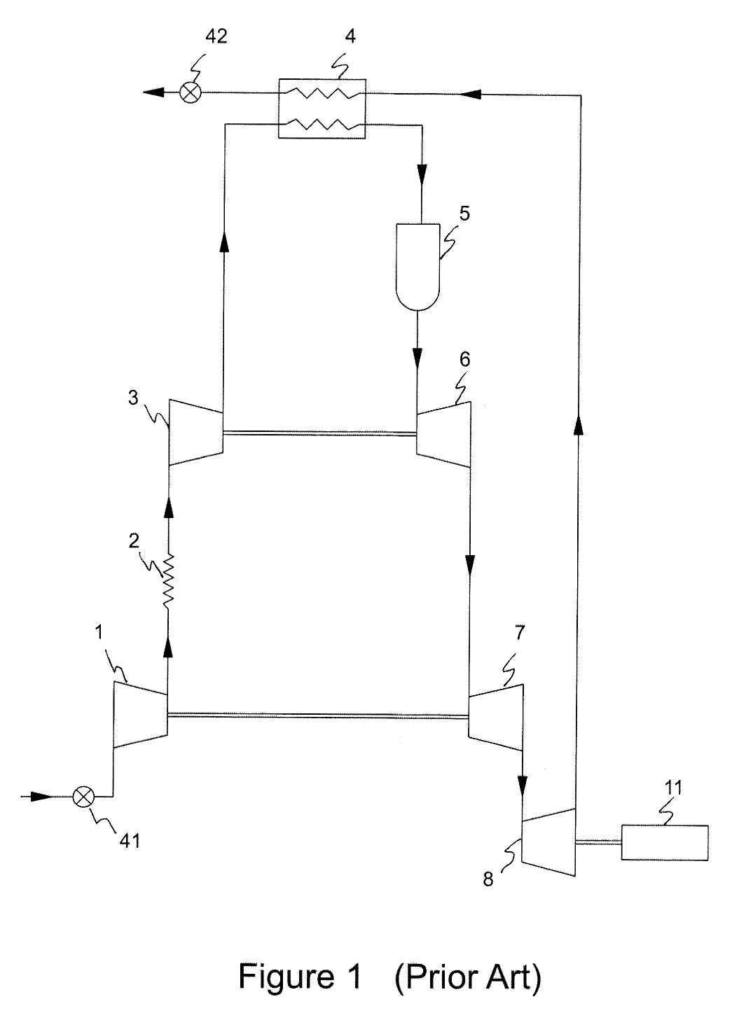

An exemplary engine is a high efficiency gas turbine engine because it typically has lower NOx emissions, is more fuel flexible and has lower maintenance costs than comparable reciprocating engines. For example, an intercooled recuperated gas turbine engine in the 10 kW to approximately 650 kW range is available with thermal efficiencies above about 40%. A schematic of the component arrangement of a prior art intercooled, recuperated gas turbine engine architecture is shown in FIG. 1.

Gas is ingested into a low pressure compressor 1. The outlet of the low pressure compressor 1 passes through an intercooler 2 which removes a portion of heat from the gas stream at approximately constant pressure. The gas then enters a high pressure compressor 3. The outlet of high pressure compressor 3 passes through the cold side of a recuperator 4 where a portion of heat from the exhaust gas is transferred, at approximately constant pressure, to the gas flow from the high pressure compressor 3. The further heated gas from the cold side of recuperator 4 is then directed to a combustor 5 where a fuel is burned, adding heat energy to the gas flow at approximately constant pressure. The gas emerging from the combustor 5 then enters a high pressure turbine 6 where work is done by turbine 6 to operate high pressure compressor 3. The gas from the high pressure turbine 6 then drives low pressure turbine 7 where work is done by turbine 7 to operate low pressure compressor 1. The gas exiting from low pressure turbine 7 then drives a free power turbine 8. The shaft of free power turbine 8, in turn, drives a transmission 11 which may be an electrical, mechanical or hybrid transmission for a vehicle. Alternately, the shaft of the free power turbine can drive an electrical generator or alternator for electrical power generation. Finally, the gas exiting free power turbine 8 flows through the hot side of the recuperator 4 where heat is extracted and used to preheat the gas just prior to entering the combustor. The gas exiting the hot side of the recuperator is then exhausted to the atmosphere. This engine design is described, for example, in U.S. patent application Ser. No. 12/115,134 filed May 5, 2008, entitled “Multi-Spool Intercooled Recuperated Gas Turbine” which is incorporated herein by this reference.

As can be appreciated, the engine illustrated in FIG. 1 can have additional components (such as for example a re-heater between the high pressure and low pressure turbines) or fewer components (such as for example a single compressor-turbine spool, or no free power turbine but shaft power coming off the low pressure turbine spool).

As can be further appreciated, the power rating of the engine design of FIG. 1 can be increased to megawatts by increasing the size of components. For larger sizes, the high temperature components such as turbine rotors, volutes and shrouds can be fabricated from ceramics or can incorporate well-known active cooling techniques of metallic components such as turbine rotors.

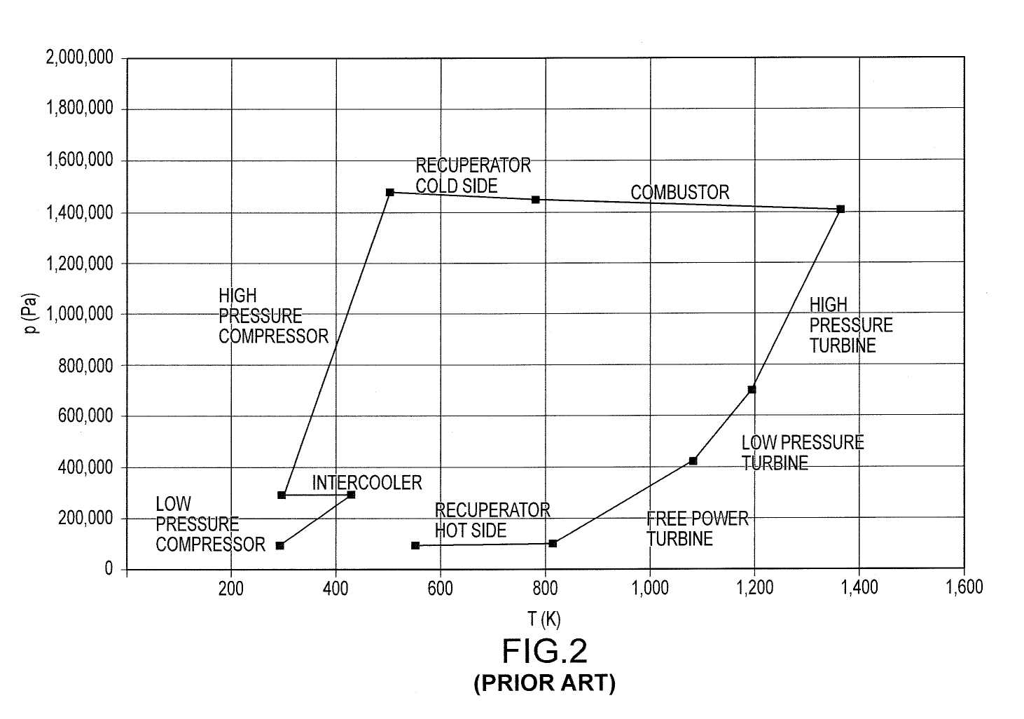

FIG. 2 illustrates an actual Brayton cycle for an intercooled, recuperated engine in a plot of pressure versus temperature. This representation corresponds to the engine architecture of FIG. 1. Gas is ingested into a low pressure compressor and the outlet of the low pressure compressor passes through an intercooler which removes a portion of heat from the gas stream at approximately constant pressure. The gas then enters a high pressure compressor and the outlet of high pressure compressor passes through the cold side of a recuperator where some heat from the exhaust gas is transferred, at approximately constant pressure, to the gas flow from the high pressure compressor. The further heated gas from the recuperator is then directed to a combustor where a fuel is burned, adding heat energy to the gas flow at approximately constant pressure. The gas emerging from the combustor then enters a high pressure turbine where work is done by the turbine to operate the high pressure compressor. The gas from the high pressure turbine then drives a low pressure turbine where work is done by the low pressure turbine to operate the low pressure compressor. The gas from the low pressure turbine then drives a free power turbine whose energy is extracted typically by a rotating shaft which can drive a transmission for a vehicle or a generator for a power plant, for example. Finally, the gas exiting the free power turbine flows through the hot side of the recuperator where heat is extracted and used to preheat the gas just prior to entering the combustor. The gas exiting the hot side of the recuperator is then exhausted to the atmosphere. The efficiency of this intercooled and recuperated Brayton cycle, which has an approximate overall pressure ratio of 14.8:1 and a peak temperature of about 1,370° K, is about 43.5% based on the low heat value (“LHV”) of methane as a fuel. This representation of an intercooled, recuperated multi-spool cycle was described in the previously referenced “Preliminary Design and Projected Performance for Intercooled Recuperated Microturbine”.

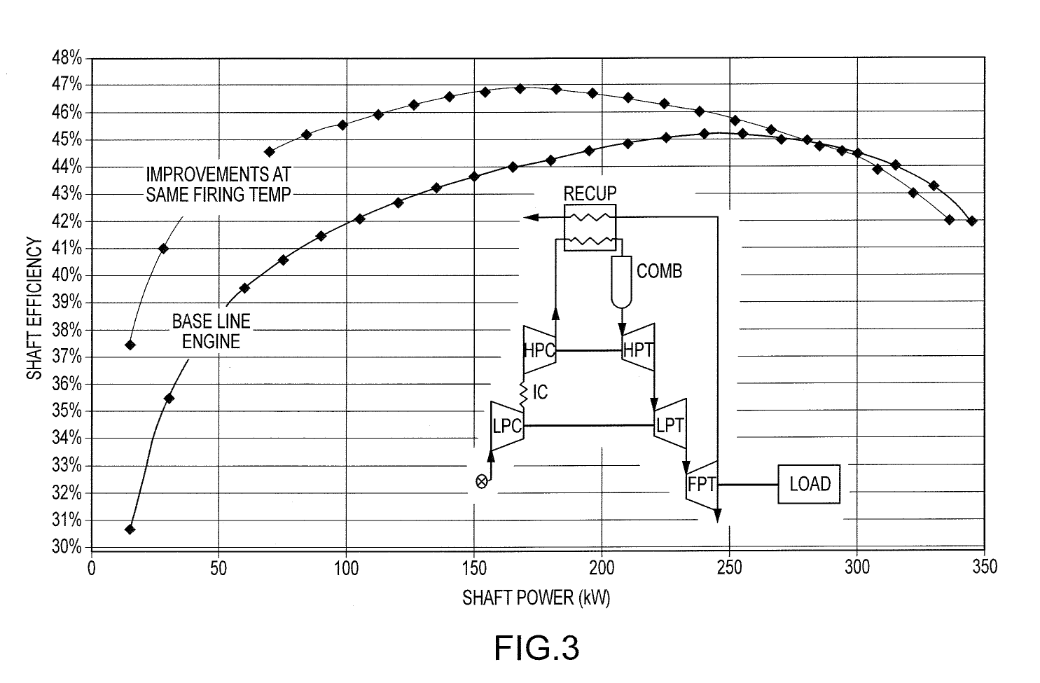

FIG. 3 illustrates typical calculated performance characteristics of the engine of FIG. 1 showing engine thermal efficiency versus engine output shaft power. As can be seen, improved versions of this engine have a relatively flat efficiency curve over wide operating range from about 20% of full power to about 85% of full power.

A gas turbine engine is an enabling engine for efficient multi-fuel use and, in particular, this engine can be configured to switch between fuels while the engine is running and the vehicle is in motion (on the fly). In addition, a gas turbine engine can be configured to switch on the fly between liquid and gaseous fuels or operate on combinations of these fuels. This is possible because combustion in a gas turbine engine is continuous (as opposed to episodic such as in a reciprocating piston engine) and the important fuel parameter is the specific energy content of the fuel (that is, energy per unit mass) not its ignition characteristics such as cetane number or octane rating. The cetane number (typically for diesel fuels and compression ignition) or octane rating (typically for gasoline fuels and spark ignition) are important parameters in piston engines for specifying fuel ignition characteristics to achieve control over the combustion process in a reciprocating engine. The multi-fuel operation of this engine is described in U.S. patent application Ser. No. 13/090,104 filed Apr. 19, 2011 entitled “Multi-Fuel Vehicle Strategy” which is incorporated herein by reference.

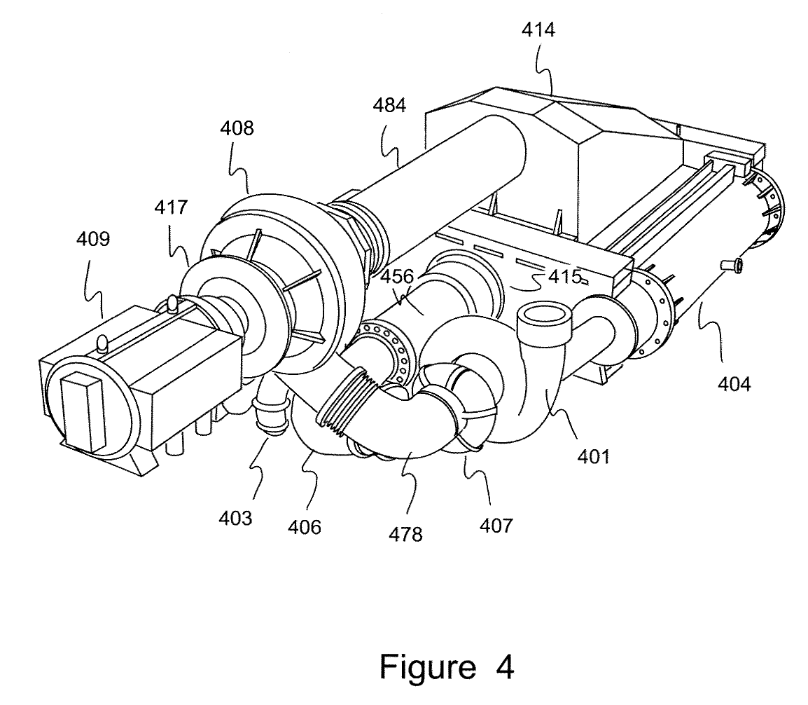

The gas turbine engine such as shown in FIG. 4 is prior art. This is an example of an approximately 375 kW engine that uses intercooling and recuperation to achieve high operating efficiencies (approximately 40% or more) over a substantial range of vehicle operating speeds. This compact engine is suitable for light to heavy trucks. Variations of this engine design are suitable for smaller vehicles as well as applications such as, for example, marine, rail, agricultural and power-generation. One of the principal features of this engine is its fuel flexibility and fuel tolerance. This engine can operate on any number of liquid fuels (gasoline, diesel, ethanol, methanol, butanol, alcohol, bio diesel and the like) and on any number of gaseous fuels (compressed or liquid natural gas, propane, hydrogen and the like). This engine may also be operated on a combination of fuels such as mixtures of gasoline and diesel or mixtures of diesel and natural gas. Switching between these fuels is generally a matter of switching fuel injection systems and/or fuel mixtures.

This engine operates on the Brayton cycle and, because combustion is continuous, the peak operating temperatures are substantially lower than comparable sized piston engines (also known as reciprocating engines) operating on either an Otto cycle or Diesel cycle. This lower peak operating temperature results in substantially less NOx emissions generated by the gas turbine engine shown in FIG. 4. This figure shows a load device 409, such as for example a high-speed alternator, attached via a reducing gearbox 417 to the output shaft of a free power turbine 408. A cylindrical duct 484 delivers the exhaust from free power turbine 408 to a plenum 414 which channels exhaust through the hot side of recuperator 404. Low pressure compressor 401 receives its inlet air via a duct (not shown) and sends compressed inlet flow to an intercooler (also not shown). The flow from the intercooler is sent to high pressure compressor 403 which is partially visible underneath free power turbine 408. As described previously, the compressed flow from high pressure compressor 403 is sent to the cold side of recuperator 404 and then to a combustor which is contained inside recuperator 404. The flow from combustor 415 (whose outlet end is just visible) is delivered to high pressure turbine 406 via cylindrical duct 456. The flow from high pressure turbine 406 is directed through low pressure turbine 407. The expanded flow from low pressure turbine 407 is then delivered to free power turbine 408 via a cylindrical elbow 478.

This engine also has a multi-fuel capability with the ability to change fuels on the fly as described previously.

### Enabling Methods and Technologies

### Non-Optimal High-Pressure Operation

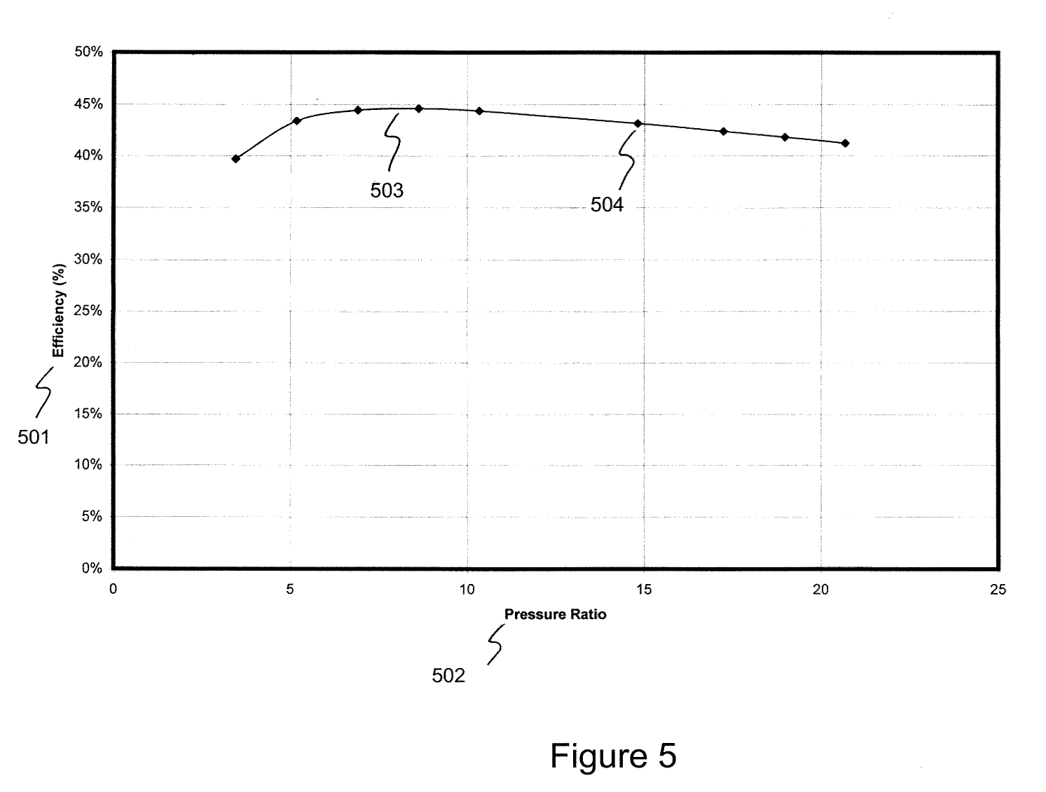

FIG. 5 illustrates a typical plot of overall engine efficiency 501 versus overall engine pressure ratio 502 for the intercooled, recuperator engine architecture shown in FIG. 1. As can be seen, maximum thermal efficiency 503 of about 44.6% occurs at an overall engine pressure ratio of about 8:1. The engine illustrated in FIG. 4 was designed based on an overall engine pressure ratio of about 14.8:1 and has a full-power thermal efficiency 504 of about 43.2%. As can be appreciated, engine size is strongly related to overall engine pressure ratio as the size of the combustor and recuperator, for example, are reduced almost directly with overall engine pressure ratio while thermal efficiency drops by about 3%. The calculations of FIGS. 2 and 3 were made for an optimized engine operating at full power with an architecture as shown in FIG. 1. As can be further appreciated, thermal efficiency will increase slightly at lower power levels such, as for example, when the engine is running at cruising speed in a vehicle application.

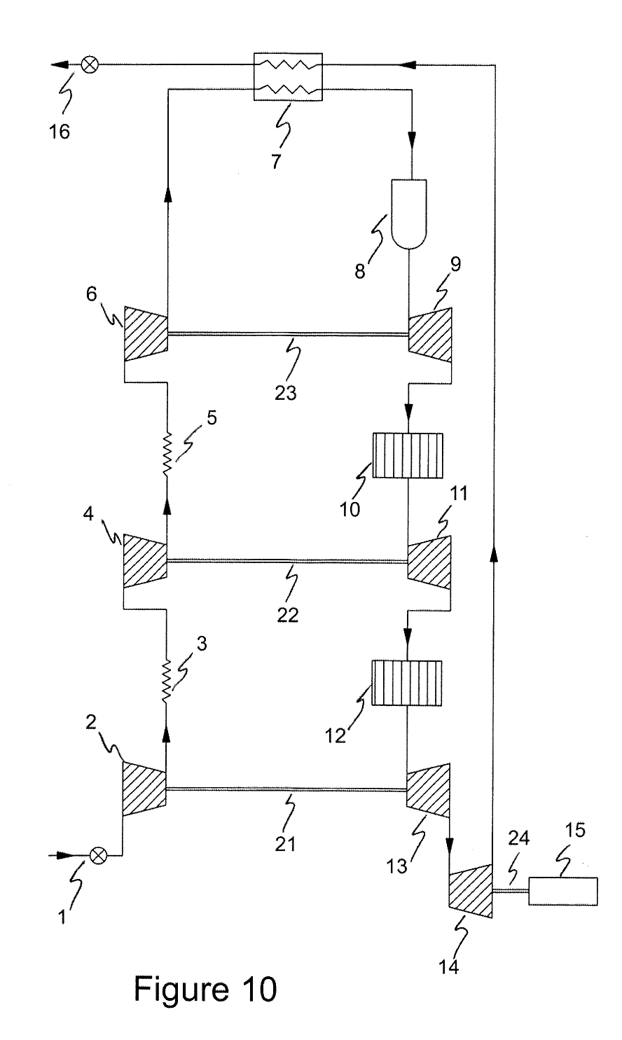

Thus a compact engine can be designed with little sacrifice in thermal efficiency by designing for a higher pressure ratio well beyond the maximum thermal efficiency point. This design approach allows the use of smaller parts such as for example turbocharger centrifugal compressors and turbocharger centrifugal turbines as well as the smaller recuperator and combustor mentioned above. At a given overall engine pressure ratio, thermal efficiencies can then be improved by utilizing ceramic components in the combustor and/or turbines which allow operation at higher temperatures. As will be described in FIGS. 10 through 12, further thermal efficiency gains can be realized by adding additional stages of intercooling and reheat. These will increase engine size but, by operating at higher pressure ratios, the overall engine size will remain well within the practical size range for vehicle and other applications.

### Ceramics Used in Gas Turbines

The present disclosure is directed specifically to a gas turbine engine that utilizes two intercoolers and two reheaters in addition to a main combustor and recuperator. The main combustor can be a conventional metallic can, cannular or annular type combustor and the two reheaters are preferably thermal reactors. As can be appreciated, the combustor may also be a thermal reactor. This gas turbine engine architecture, operating at a high pressure ratio (typical range of about 10:1 to about 20:1) and high combustor exit temperature (typical range of about 1,300° K to about 1,700° K) can have thermal efficiencies approaching or exceeding 50%, thermal efficiency being based on output shaft power and low heat value (“LHV”) of the fuel. This gas turbine engine cycle begins to close the efficiency gap between a practical gas turbine engine cycle and the limiting maximum possible efficiency of an ideal Carnot cycle. As is well known, the ideal Carnot cycle is the most efficient thermodynamic cycle between two temperatures although it is difficult to even approximate with a practical engine.

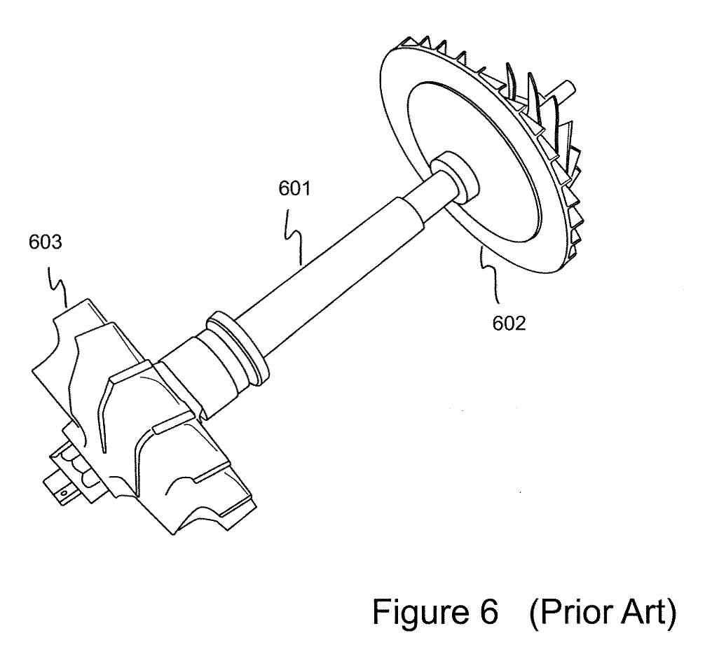

FIG. 6 shows a turbo-compressor spool with a metallic compressor rotor and a ceramic turbine rotor. This turbo-compressor spool design was described in the previously referenced “Preliminary Design and Projected Performance for Intercooled Recuperated Microturbine”. This figure illustrates a compressor/turbine spool typical of use in a high-efficiency gas turbine operating in the output power range of about 300 to about 750 kW. A metallic compressor rotor 602 and a ceramic turbine rotor 603 are shown attached to the opposite ends of a metal shaft 601. The ceramic rotor shown here is a 95-mm diameter rotor fabricated from silicon nitride and was originally designed for use in turbocharger applications. As can be seen, the joint between the ceramic rotor and metallic shaft is close to the ceramic rotor and is therefor exposed to high temperatures of the gas products passing through the turbine. Alternate metallic-ceramic joint locations are discussed in U.S. patent application Ser. No. 13/476,754 entitled “Ceramic-to-Metal Turbine Shaft Attachment”, filed on May 20, 2012 which is incorporated herein by reference.

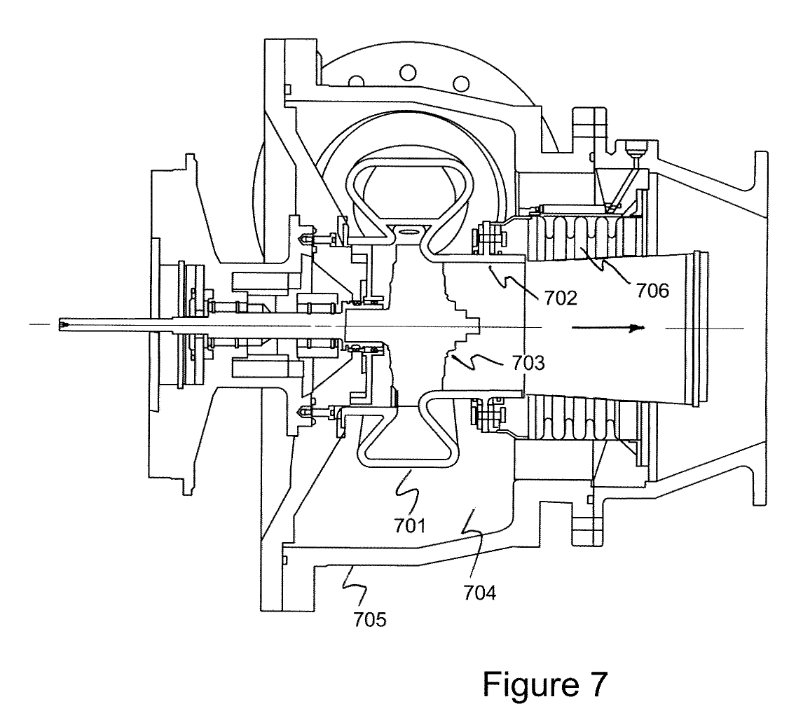

FIG. 7 is schematic of a gas turbine compressor/turbine spool comprising a ceramic volute, rotor and shroud. A ceramic turbine rotor 703 is shown inside a ceramic shroud 702 which is integral with a ceramic volute 701. The volute, shroud and rotor are housed inside a metal case 704. For example the ceramic rotor can be fabricated from silicon nitride and is capable of operating safely at turbine inlet temperatures of up to about 1,500° K. The use of a rotor and shroud fabricated from the same or similar ceramics controls shroud line clearances and maintains high rotor efficiency by controlling the clearance and minimizing parasitic flow leakages between the rotor blade tips and the shroud. This configuration of volute, shroud and rotor is described in U.S. patent application Ser. No. 13/180,275 entitled “Metallic Ceramic Spool for a Gas Turbine Engine” filed Jul. 11, 2011 which is incorporated herein by reference.

### Turbocharger Components

As used herein, ‘turbocharger-like architecture” or “turbocharger technology” means spools which are derived from modified stock turbocharger hardware components. Centrifugal compressors and radial in-flow turbines are sometimes called radial compressors and turbines.

Centrifugal compressors and their corresponding radial in-flow turbines may be arranged to minimize the length of connecting duct work (close-coupled) and to be rotatable (reconfigurable) to allow the other major components of the engine, such as the intercooler, recuperator, combustor and load device to be connected in such a way as to minimize engine volume for applications such as vehicle engines and stationary power generation modules.

The advantages of turbo-charger-like architecture are discussed in U.S. patent application Ser. No. 13/226,156 entitled “Gas Turbine Engine Configurations” filed Sep. 6, 2011 and in U.S. Provisional Application No. 61/548,419 entitled “Gas Turbine Engine Component Axis Configurations” filed Oct. 18, 2011, both of which are incorporated herein by reference.

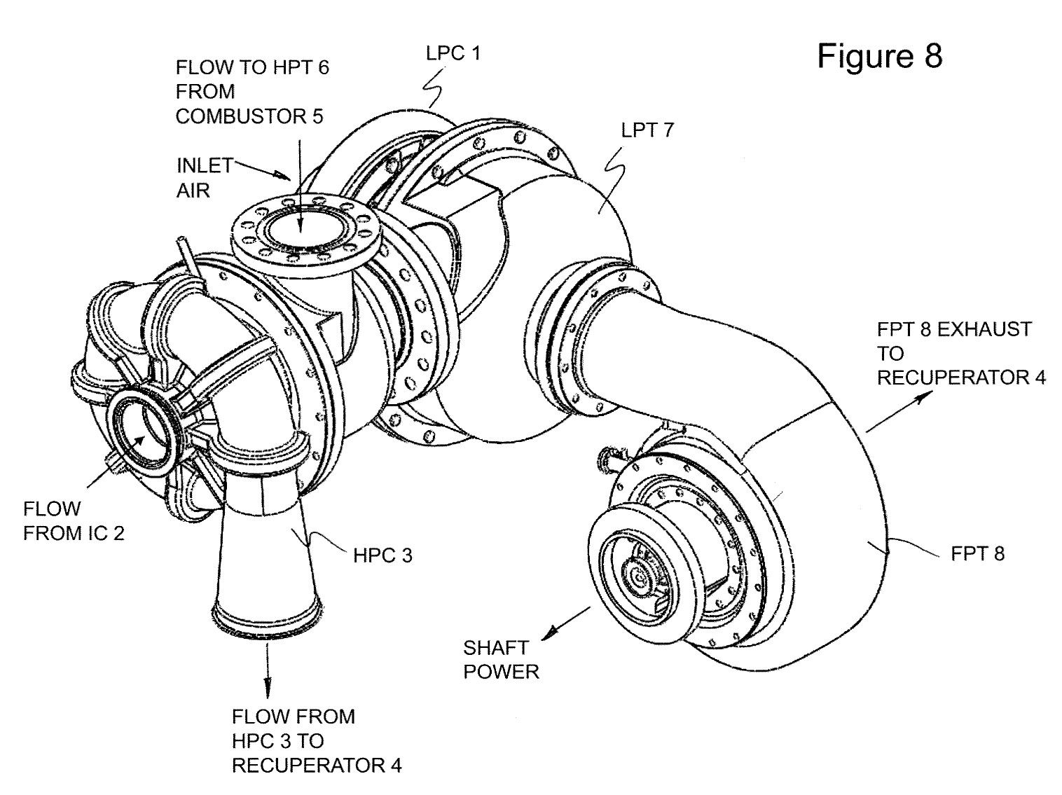

FIG. 8 is an isometric view of various gas turbine engine components. The working fluid (air or, in some engine configurations, an air-fuel mixture) enters low pressure compressor 1 and the resulting compressed flow is sent to an intercooler (not shown). Flow from the intercooler enters high pressure compressor 3 and the resulting further compressed flow is sent to the cold side of a recuperator (not shown). Flow from a combustor (not shown) enters high pressure turbine 6, is expanded and sent to low pressure turbine 7 where it is further expanded and delivered to free power turbine 8. In this engine configuration, free power turbine 8 provides the primary mechanical shaft power of the engine. The flow from free power turbine 8 is sent to the hot side of the recuperator (not shown).

As can be seen from FIG. 8, components can be rotated relative to other components. Low pressure compressor 1 can be rotated relative to the other components to vary the exit direction of the compressed flow to the intercooler (not shown). Similarly, high pressure compressor 3 can be rotated relative to the other components to vary the inlet direction from the intercooler (not shown). High pressure turbine 6 can be rotated relative to the other components to vary the inlet direction from the combustor (not shown). Free power turbine 8 can be rotated relative to the other components to vary the direction of its outlet flow to the recuperator (not shown) and the direction of the output mechanical power shaft. This flexibility allows the other major engine components (intercooler, recuperator, combustor and load device) to be positioned where they best fit the particular engine application (for example vehicle engine, stationary power engine, nested engines and the like). This figure is described in the previously referenced U.S. patent application Ser. No. 13/226,156.

### The Thermal Reactor (Thermal Oxidizer)

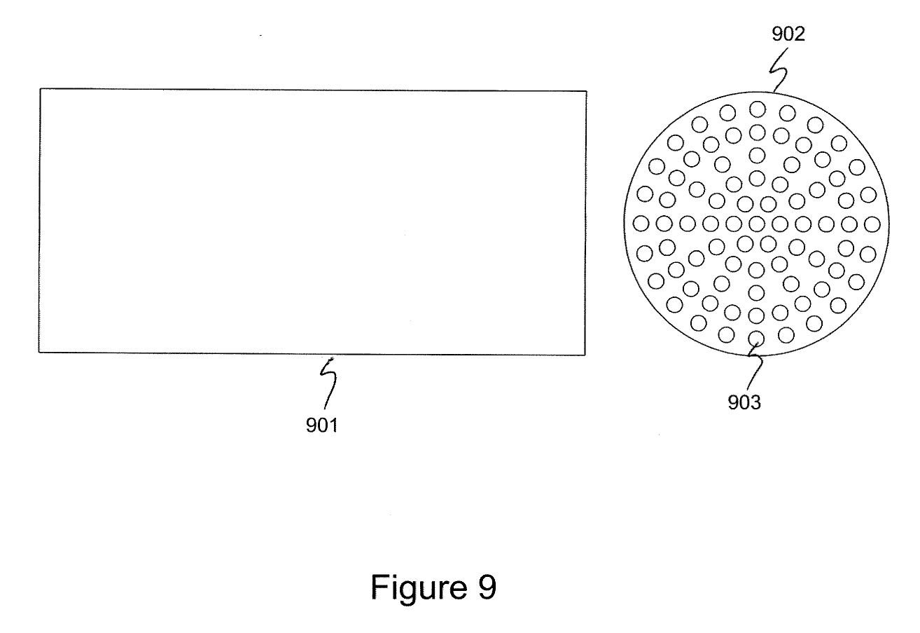

FIG. 9 shows a schematic view of a thermal reactor that may be used as a reheater (a thermal reactor is sometimes also called a thermal oxidizer). A thermal reactor is prior art. The design of the thermal reactor is a cylindrical device with a number of small diameter channels that allow a simple flow pattern for the fuel-air mixture. This is an example of a honeycomb version of a thermal reactor. As the reaction of fuel and air proceeds, the temperature of the gas increases. As can be appreciated, a thermal oxidizer type of combustor can be substituted for a metallic can-type combustor. Compact thermal reactors are discussed in U.S. Provisional Application 61/643,787 entitled “Thermal Reactor Combustion System for a Gas Turbine Engine”, filed on May 7, 2012 which is incorporated herein by reference.

It is important to note the differences between a thermal reactor and a combustor. A combustor typically supports a deflagration type of combustion. Deflagration is a rapid, subsonic energy release combustion event that propagates through a gas or across the surface of a combustible material at subsonic speeds primarily in a flame front. It is driven by compression heating of the material ahead of the flame front which increases the reaction rate. Deflagration is different from detonation, which is supersonic and reacts the fuel rapidly through shock heating. The underlying flame physics of deflagrating combustion can be understood with the help of an idealized model consisting of a uniform one-dimensional tube of unburnt and burned gaseous fuel, separated by a thin transitional region of width in which the burning occurs. The burning region is commonly referred to as the flame or flame front. In equilibrium, thermal diffusion across the flame front is balanced by the heat supplied by burning.

In a thermal reactor, an air/fuel mixture undergoes a thermal oxidation process in an oxidation reaction chamber. The fuel concentration in the air/fuel mixture is below a lower explosive limit concentration of the fuel. The mixture is received while a temperature of a region in the oxidation reaction chamber is below an oxidation temperature sufficient to oxidize the fuel. The temperature of the region is raised to at least the oxidation temperature primarily using heat energy released from oxidizing the air/fuel mixture in the reaction chamber. Raising the temperature of the region includes transferring the heat energy to the region by convection and/or conduction. The temperature of the region is maintained at least at the oxidation temperature primarily using heat energy released from oxidizing the air/fuel mixture in the reaction chamber. The temperature substantially throughout the oxidation reaction chamber is typically maintained below a temperature that causes significant formation of nitrogen oxides. The air/fuel mixture is received in the oxidation reaction chamber while at least 95 percent of an internal volume of the oxidation reaction chamber is below the oxidation temperature. The received air/fuel mixture cannot sustain a flame.

A combustor includes a zone for nearly adiabatic, deflagrating combustion of a fuel-air mixture. In a combustor, a fraction of the incoming air is typically diverted around the zone for combustion of the fuel-air mixture and is used to cool the inner combustion chamber as well as to mix with the combustion products to achieve the desired combustor exit temperature. Thermal reactors or reactor beds, on the other hand, provide for non-adiabatic, continuous oxidizing reaction within the small channels or interstitial spaces of the reactor. An ideal combustor transfers no heat to the walls of the combustor, while an ideal thermal reactor transfers some of the heat of combustion to the walls of the reactor bed. As such, a thermal reactor or reactor bed is not a combustor, and a combustor is not a thermal reactor. This distinction is described in U.S. Pat. No. 6,895,760 entitled “Microturbine for Combustion of VOCs” issued May 24, 2005, which is incorporated herein by reference.

The reactor bed may include a matrix of pebbles or a honeycomb structure, and may employ refractory or ceramic materials taking one of several forms including pebbles, structured foams, sintered powder, and extruded honeycomb material. In the following figures, a honeycomb version is assumed.

As can be appreciated, the air-fuel mixture flow is essentially one-dimensional and reaction of fuel and air is spread out. This allows the reactive flow in the thermal reactor to remain stable in power-down (turn-down) as well as reducing emissions since maximum temperature is the exit temperature.

Engine with Multiple Intercools and Reheats

The present disclosure is directed specifically to a gas turbine engine that utilizes at least two intercoolers and at least one or more reheaters in addition to a main combustor and recuperator. The main combustor can be a conventional metallic can, cannular or annular type combustor and the two reheaters are preferably thermal reactors. As can be appreciated, the combustor may also be a thermal reactor. This gas turbine engine architecture, operating at a high pressure ratio (typical range of about 10:1 to about 20:1) and high combustor exit temperature (typical range of about 1,300° K to about 1,700° K) can have thermal efficiencies approaching or exceeding 50%, thermal efficiency being based on output shaft power and low heat value (“LHV”) of the fuel. This gas turbine engine cycle begins to close the efficiency gap between a practical gas turbine engine cycle and the limiting maximum possible efficiency of an ideal Carnot cycle. As is well known, the ideal Carnot cycle is the most efficient thermodynamic cycle between two temperatures though it is difficult to even approximate with a practical engine.

As discussed previously, gas turbine engines incorporating intercooled reheat cycles have had serious technical challenges with the reheat combustors down-stream of the first main combustor. These reheater difficulties include:
turn-down stability of the combustion process;
unacceptable pressure drop due to high flow velocity and temperatures; and
requirement for high temperature combustor liners.

The approach to overcoming the above mentioned difficulties is a gas turbine engine architecture that employs multiple stages of intercooling and reheaters. This approach includes:
utilizing a conventional dry low NOx (“DLN”) combustor for the main combustor; and
utilizing thermal reactors (also known as thermal oxidizers) for the reheat apparatuses.

A thermal reactor can operate at a high inlet temperature which accelerates the reaction within a small matrix such as provided by a ceramic honeycomb thermal reactor, for example. This type of thermal reactor can be designed to have a low pressure drop, exhibit little or no liner over-heating and not exhibit combustion stability problems in turn down.

The present disclosure is directed specifically to increasing gas turbine engine thermal efficiency to levels approaching and exceeding 50% utilizing multiple stages of intercooling and reheating, ceramic technology, turbocharger technology and high pressure combustion. When all of these are combined, the engine can still retain its low emission characteristics and compact size characteristics. As noted previously, maximum thermal efficiency occurs at a specific overall engine pressure ratio. By operating at a significantly higher pressure ratio (about 1.5 to about 2.5 times the optimum pressure ratio), thermal efficiency drops off slowly whereas engine size decreases relatively rapidly with increasing overall engine pressure ratio. Further, the enabling turbocharger and ceramic technologies allow a compact engine to be built where the gas turbine engine cycle begins to close the efficiency gap between a practical gas turbine engine cycle and the limiting maximum possible efficiency of an ideal Carnot cycle. This is accomplished by employing two intercoolers and two reheaters in addition to a main combustor and recuperator. As is well known, the ideal Carnot cycle is the most efficient thermodynamic cycle between two temperatures although it is difficult to even approximate with a practical engine.

As small gas turbine engines achieve higher and higher combustion outlet temperatures, it may be necessary to replace the recuperator of the current design with a regenerator. Regenerators can typically function better than recuperators at higher temperatures (above about 1,800° K). An example of a suitable regenerator design is disclosed in U.S. patent application Ser. No. 13/481,469 entitled “Rotary-Valved Multi-Chambered Regenerator” filed May 25, 2012 and is incorporated herein by reference.

FIG. 10 shows an architecture for an intercooled, recuperated gas turbine with multiple heat rejections and additions utilizing three separate turbo-compressor spools and a free power turbine spool. The working fluid (typically air) is ingested at inlet 1 and fed to compressor 2. Heat is extracted by a first intercooler 3 and then delivered to compressor 4. Additional heat is extracted by a second intercooler 5 and then delivered to compressor 6. The output of compressor 6 is input into the cold side of recuperator 7 where heat from the exhaust stream is added. The working fluid is then introduced along with fuel to combustor 8 which brings the combustion products at approximately constant pressure to their maximum temperature. The combustion products are expanded through turbine 9 which powers compressor 6. The output of turbine 9 is then passed through a first thermal reactor 10 which adds and reacts additional fuel to generate additional heat at approximately constant pressure in the reaction products. The flow then enters turbine 11 where it is expanded through turbine 11 which powers compressor 4. The output of turbine 11 is then passed through a second thermal reactor 12 which adds and reacts additional fuel at approximately constant pressure to generate additional heat in the reaction products. The flow then enters turbine 13 where it is expanded through turbine 13 which powers compressor 2. The output of turbine 13 then enters free power turbine 14 which rotates shaft 24 which in turn delivers power to load 15. The output of free power turbine 14 is then passed through the hot side of recuperator 7 where heat is extracted and used to heat the flow that is about to enter the combustor 8. The flow from the hot side of recuperator 7 is then exhausted to the atmosphere 16.

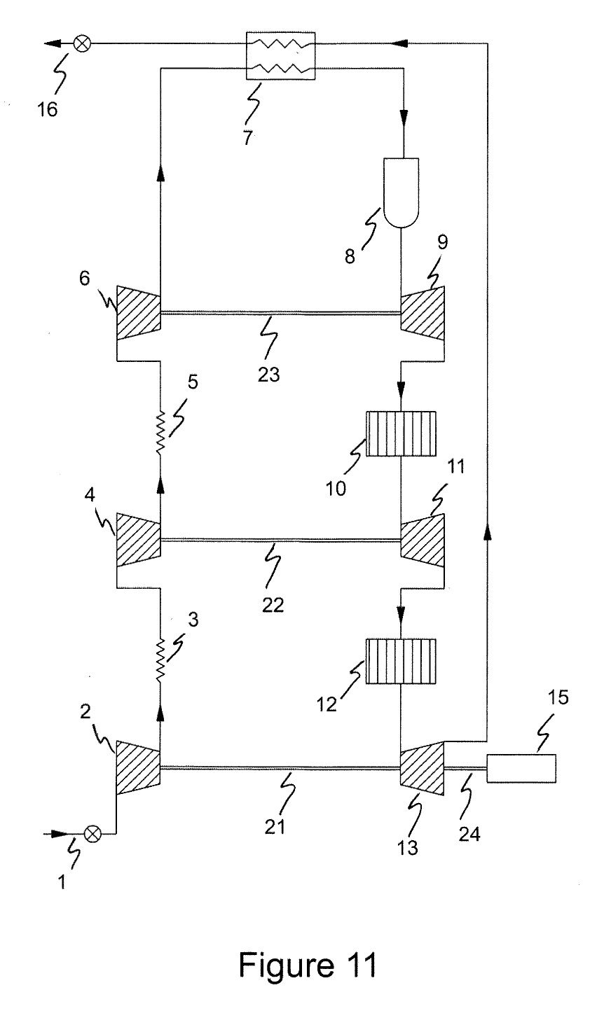

FIG. 11 shows an architecture for an intercooled, recuperated gas turbine with multiple heat rejections and additions utilizing three separate turbo-compressor spools. The working fluid (typically air) is ingested at inlet 1 and fed to compressor 2. Heat is extracted by a first intercooler 3 and then delivered to compressor 4. Additional heat is extracted by a second intercooler 5 and then delivered to compressor 6. The output of compressor 6 is input into the cold side of recuperator 7 where heat from the exhaust stream is added. The working fluid is then introduced along with fuel to combustor 8 which brings the combustion products at approximately constant pressure to their maximum temperature. The combustion products are expanded through turbine 9 which powers compressor 6. The output of turbine 9 is then passed through a first thermal reactor 10 which adds and reacts additional fuel to generate additional heat at approximately constant pressure in the reaction products. The flow then enters turbine 11 where it is expanded through turbine 11 which powers compressor 4. The output of turbine 11 is then passed through a second thermal reactor 12 which adds and reacts additional fuel to generate additional heat at approximately constant pressure in the reaction products. The flow then enters turbine 13 where it is expanded through turbine 13 which powers compressor 2. In this configuration, turbine 13 rotates shaft 24 which in turn delivers power to load 15.

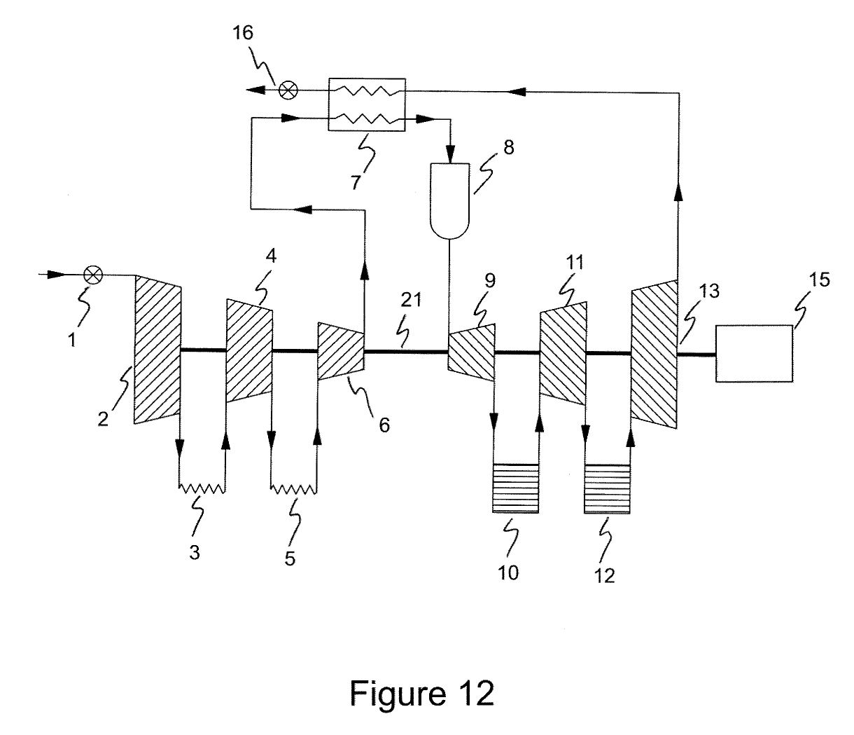

FIG. 12 shows an alternate architecture for an intercooled, recuperated gas turbine with multiple heat rejections and additions with all the compressors and turbines on a single shaft. The sequence of thermodynamic processes are the same as those described in FIG. 11. A disadvantage of this configuration is that all compressor/turbine stages would have the same rotational speed (unless gearing were used between components) and this would put an additional constraint on the design of the compressors and turbines.

In summary, the present disclosure is directed specifically to a gas turbine engine that utilizes at least two intercoolers and one of more reheaters in addition to a main combustor and recuperator. The main combustor can be a conventional metallic can, cannular or annular type combustor and the two reheaters are preferably thermal reactors. As can be appreciated, the combustor may also be a thermal reactor. This gas turbine engine architecture, operating at a high pressure ratio (typical range of about 10:1 to about 20:1) and high combustor exit temperature (typical range of about 1,300° K to about 1,700° K) can have thermal efficiencies approaching or exceeding 50% (thermal efficiency being based on output shaft power and low heat value (“LHV”) of the fuel).

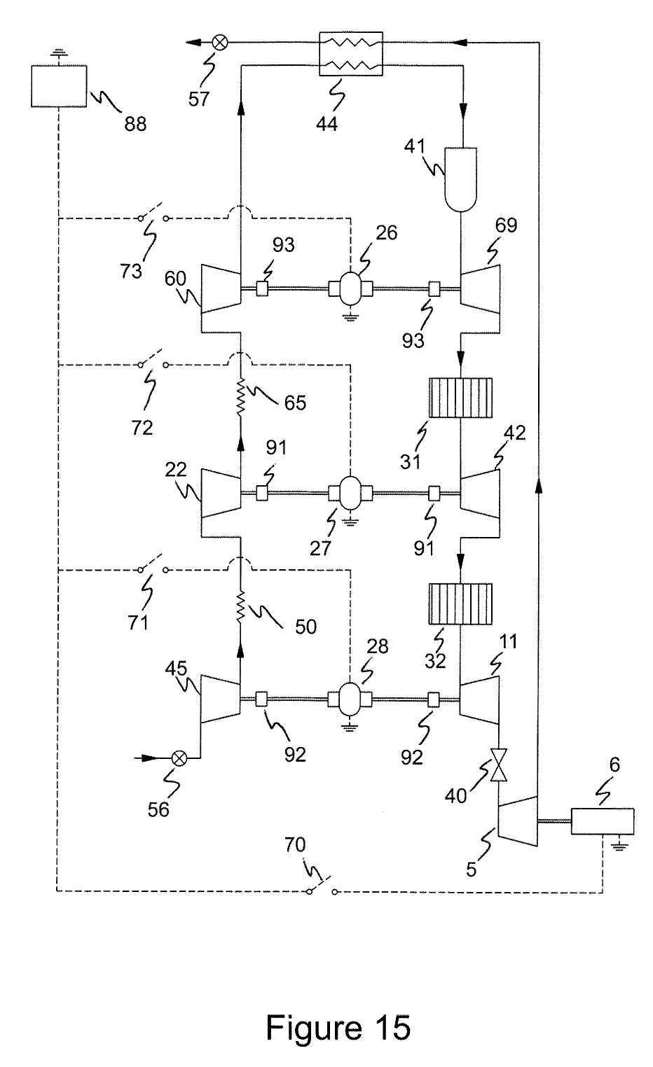

Although not shown in FIG. 10, 11 or 12, the engine preferably includes a variable area nozzle just upstream of the lowest pressure turbine. Such a variable are nozzle is a primary control for engine mass flow. FIG. 15 illustrates such a variable area nozzle for the configuration with a free power turbine.

As can be further appreciated, the power rating of the engine design of FIGS. 10, 11 and 12 can be increased to megawatts by increasing the size of components. For larger sizes, the high temperature components such as turbine rotors, volutes and shrouds can be fabricated from ceramics or can incorporate well-known active cooling techniques of metallic components such as turbine rotors.

### Principles of Engine Efficiency

The Carnot cycle is the most efficient existing cycle capable of converting a given amount of thermal energy into work. In the process of going through this cycle, the system may perform work, thereby acting as a heat engine. Such a perfect engine is only theoretical and cannot be built in practice. The Carnot cycle is a reversible cycle between two temperatures wherein heat is absorbed along the higher isotherm at Tmax and heat is rejected along the lower isotherm at Tmin.

The Carnot cycle when acting as a heat engine includes the following steps:
isothermal absorption of heat Qin at Tmax
isentropic expansion cooling the gas from Tmax to Tmin
isothermal rejection of heat Qout at Tmin
isentropic compression heating the gas from Tmin back to Tmax.

This cycle applies to any working material so its efficiency easily can be evaluated by choosing an ideal gas.

pV=RT

and

pV̂γ=constant for an isentropic process
where p=pressure, V=volume and γ=ratio of specific heats.

Work=Qin−Qout

and

efficiency, η=Work/Qin=(Qin−Qout)/Qin
using ideal gas:

η=(Tmax−Tmin)/Tmax

In order to approach the Carnot efficiency, the processes involved in the heat engine cycle must be reversible and involve no change in entropy. This means that the Carnot cycle is an idealization, since no real engine processes are completely reversible and all real physical processes involve some increase in entropy.

The efficiency of a Carnot engine cycle is (Tmax−Tmin)/Tmax. For the engine of FIGS. 1 and 2, the maximum temperature is the turbine inlet temperature of 1,366° K and the minimum temperature is the inlet air temperature of 288° K. Thus the Carnot efficiency is 0.789 or 78.9%.

The Brayton cycle is a thermodynamic cycle that describes the workings of the gas turbine engine. It is also sometimes known as the Joule cycle. The ideal Brayton cycle includes:
1. an isentropic compression process;
2. an isobaric process of combustion where fuel is burned;
3. an isentropic expansion process where the energized fluid gives up its energy, expanding through a turbine (or series of turbines). Some of the work extracted by the turbine(s) is used to drive the compressor(s); and
4. an isobaric process where low grade heat is rejected to the atmosphere.

The efficiency of an ideal Brayton engine cycle is 1−pr̂((1−γ)/γ) where pr=pressure ratio and γ=ratio of specific heats. For the engine of FIGS. 1, 2 and 3, the pressure ratio pr=14.8:1 and the average ratio of specific heats is 1.35. Thus the simple, ideal Brayton cycle efficiency is about 0.503 or 50.3%. In this example, the maximum temperature is the turbine inlet temperature of 1,366° K and the minimum temperature is the inlet air temperature of 288° K, the same values as used in the Carnot cycle efficiency calculation.

An actual Brayton cycle, where the compression and expansion of the working fluid is not perfectly isentropic because of irreversible flow processes and other losses, includes:
1. an adiabatic compression process;
2. an approximately isobaric process of combustion where fuel is burned;
3. an adiabatic expansion process where the energized fluid gives up its energy, expanding through a turbine (or series of turbines) where some of the work extracted by each turbine is used to drive it corresponding compressor: and
4. an isobaric process where low grade heat is rejected to the atmosphere.

For the actual engine described in FIGS. 1, 2 and 3, the efficiency is about 0.435 or 43.5%. Again, the maximum temperature is the turbine inlet temperature of 1,366° K and the minimum temperature is the inlet air temperature of 288° K.

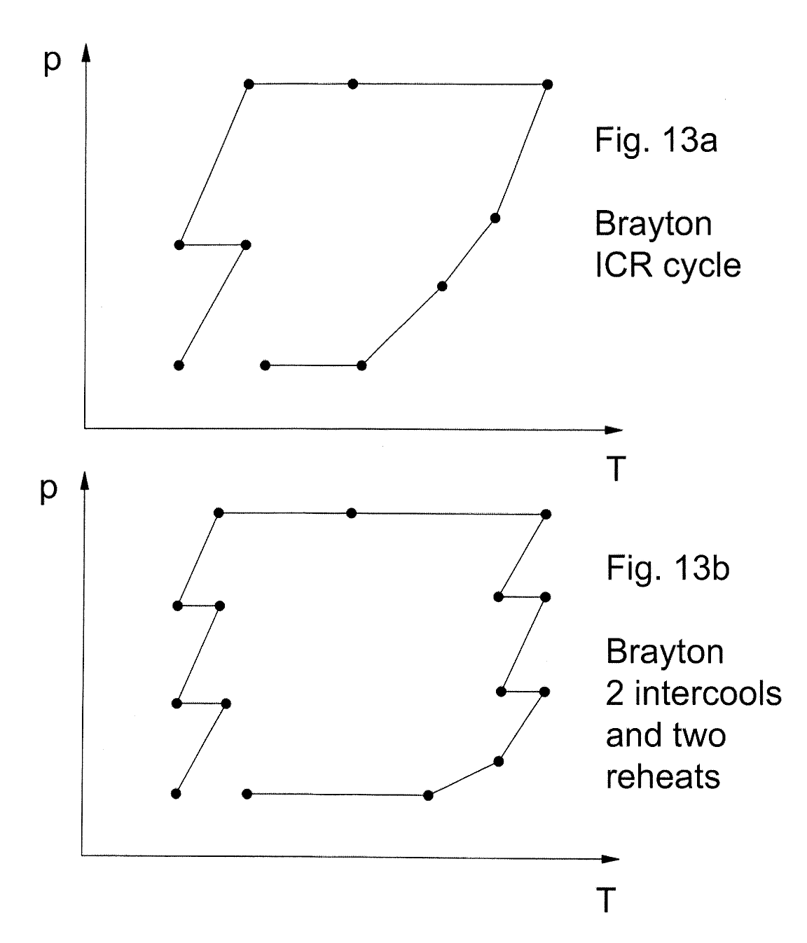

FIG. 13 illustrates the form of a Brayton cycle for two intercooled, recuperated multi-spool engine architectures. Both are shown in a pressure versus temperature diagram. FIG. 13a shows an intercooled and recuperated Brayton cycle with a free power turbine such as described in FIG. 1 and shown quantitatively for a approximately 370 kW engine in FIG. 2. FIG. 13b shows a recuperated gas turbine cycle with two intercools and two reheats. It applies to an engine with three spools each with a compressor and turbine, and a fourth spool consisting of a free power turbine and its power output shaft. Both cycles begin at the same inlet pressure and temperature and both achieve the same pressure and temperature at the high pressure turbine inlet. The recuperated gas turbine cycle with two intercools and two reheats is expected to be the higher efficiency cycle with an efficiency of about 4 to about 6 points higher than the intercooled, recuperated gas turbine engine of FIG. 13a.

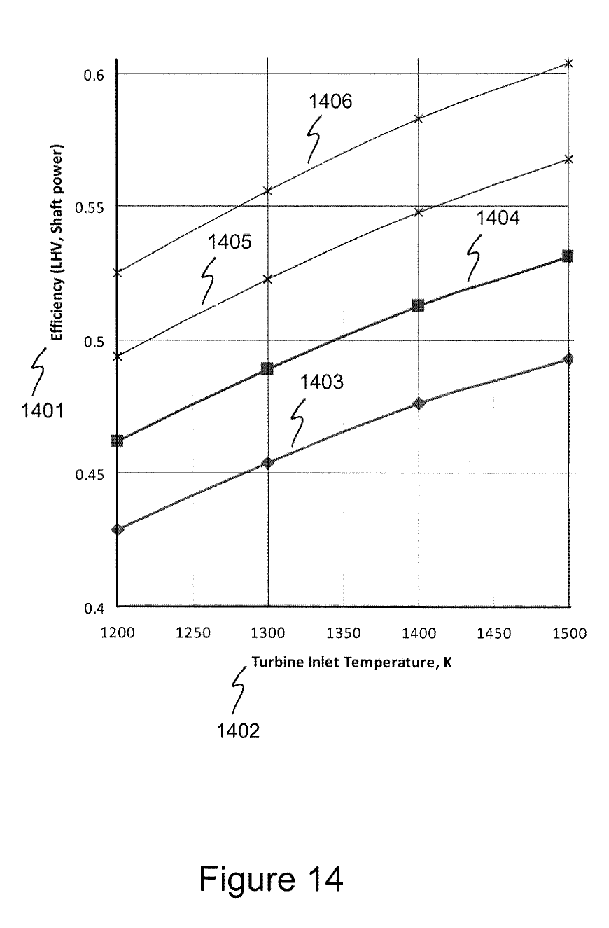

FIG. 14 is a plot of engine shaft efficiency versus turbine inlet temperature for various engine architectures. In order of increasing efficiency, the cycles are:
1. A recuperated cycle with no intercooling or reheating, curve 1403;
2. The engine cycle of FIG. 1 with an intercooler and recuperator, curve 1404;
3. The engine cycle of FIG. 1 with a reheater between the low pressure turbine and the free power turbine, curve 1405; and
4. The engine cycle of FIG. 10, 11 or 12 with two intercooling and two reheat steps in addition to the combustor and recuperator, curve 1406.

In an all-metallic engine, the peak temperatures, which are generally taken at the turbine inlet of the turbine at the exit of the combustor, are limited to about 1,200° K. At this temperature the efficiencies as shown in FIG. 14 are:
1. About 43% for the recuperated cycle with no intercooling or reheating, curve 1403;
2. About 46% for the engine cycle of FIG. 1, curve 1404;
3. About 49% for the engine cycle of FIG. 1 with a reheater between the low pressure turbine and the free power turbine, curve 1405; and
4. About 52.5% for The engine cycle of FIG. 10, 11 or 12 with two intercooling and two reheat steps in addition to the combustor and recuperator, curve 1406.

In an engine with a ceramic high pressure turbine rotor, the peak temperatures, which are generally taken at the turbine inlet of the turbine at the exit of the combustor, have been limited to about 1,370° K. At this temperature, the efficiencies are:
1. About 47% for the recuperated cycle with no intercooling or reheating, curve 1403;
2. About 51% for the engine cycle of FIG. 1, curve 1404;
3. About 54% for the engine cycle of FIG. 1 with a reheater between the low pressure turbine and the free power turbine, curve 1405; and
4. About 57.5% for The engine cycle of FIG. 10, 11 or 12 with two intercooling and two reheat steps in addition to the combustor and recuperator, curve 1406.

In an engine with additional ceramic components, the peak temperatures, which are generally taken at the turbine inlet of the turbine at the exit of the combustor, may be readily increased to about 1,500° K. At this temperature, the efficiencies are:
1. About 49% for the recuperated cycle with no intercooling or reheating, curve 1403.
2. About 53% for the engine cycle of FIG. 1, curve 1404.
3. About 56% for the engine cycle of FIG. 1 with a reheater between the low pressure turbine and the free power turbine, curve 1405.
4. About 60.5% for the engine cycle of FIG. 10, 11 or 12 with two intercooling and two reheat steps in addition to the combustor and recuperator, curve 1406.

The above efficiencies are computed for ideal conditions (no pressure losses, no bearing losses, 100% isentropic compressors and turbines, etcetera) but are indicative of the level of efficiency gains associated with higher turbine inlet temperatures and use of additional intercooling and reheating stages. As can be seen, an approximately 6% to 7% efficiency gain may be possible in going from an intercooled, recuperated design such as the engine of FIG. 1 to a recuperated engine with two intercooling and two reheat stages such as the engine of FIG. 10. An additional approximately 2% efficiency gain may be possible in going from a turbine inlet temperature of 1,370° K to 1,500° K.

Increasing turbine inlet temperature of 1,370° K to 1,500° K or higher is feasible using ceramic components for the two turbine stages after the combustor. These would be turbines constructed as shown, for example, in FIGS. 6 and 7. Increasing efficiency by adding additional intercooling and reheat stages has been demonstrated. However, implementing these in a relatively compact engine package requires the use of compact turbocharger spools, operation at relatively high engine pressure ratio (substantially above that calculated for maximum efficiency), use of advanced techniques for reducing the size of thermal reactors and other techniques such as redesigned ceramic-metallic joints on the spools.

### Control of Multi-Spool Cycles

FIG. 15 illustrates motor/generators as part of each turbo-compressor spool for a high-efficiency multi-spool engine configuration with two stages of intercooling and reheat and includes an electrical system for independently controlling motor/generators. This figure was taken from U.S. patent application Ser. No. 13/175,564 entitled “Improved Multi-Spool Intercooled Recuperated Gas Turbine” filed Jul. 1, 2011 and is incorporated herein by reference.

The working fluid (typically air) is ingested at inlet 56 and fed to compressor 45. Heat is extracted by a first intercooler 50 and then delivered to compressor 22. Additional heat is extracted by a second intercooler 65 and then delivered to compressor 60. The output of compressor 60 is input into the cold side of recuperator 44 where heat from the exhaust stream is added. The working fluid is then introduced along with fuel to combustor 41 which brings the combustion products at approximately constant pressure to their maximum temperature. The combustion products are expanded through turbine 69 which extracts work to power compressor 60. The output of turbine 69 is then passed through a first thermal reactor 31 which adds and combusts additional fuel to add additional enthalpy to the gas flow at approximately constant pressure. The flow then enters turbine 42 where it is expanded through turbine 42 which extracts work to power compressor 22. The output of turbine 42 is then passed through a second thermal reactor 32 which adds and combusts additional fuel to add additional enthalpy to the gas flow at approximately constant pressure. The flow then enters turbine 11 where it is expanded through turbine 11 which extracts work to power compressor 45. The output of turbine 11 then passes through variable area nozzle 40 (which is a primary control for mass flow) and then enters free power turbine 5 which rotates shaft 24 which in turn delivers power to load 6. The output of free power turbine 5 is then passed through the hot side of recuperator 44 where heat is extracted and used to heat the flow that is about to enter the combustor 41. The flow from the hot side of recuperator 44 is then exhausted to the atmosphere 57

FIG. 15 further shows compact motor/generator combinations 26, 27 and 28 between their respective turbines and compressors and are shown connected to an electrical control circuit. As can be appreciated, these motor/generator combinations may be connected externally to either their respective compressor or turbine rather than be located on or in the connecting shafts. The electrical circuit consists of an electrical energy storage pack 88 (which may be a battery used mainly for engine starting or a battery energy storage pack capable of providing a significant short term power boost) and, as part of load 6, a hybrid transmission which has the capability to generate electrical energy when braking. As can be appreciated, an optional thermal energy storage or flywheel energy storage system (not shown in this example) can be included. The electrical circuit also includes switches 70, 71, 72 and 74. The electrical circuit may also include an auxiliary power unit for drawing small amounts of power for lighting and heating. The electrical circuit may also include a resistive dissipating grid such as used in dynamic braking applications where electrical energy is converted into heat energy which can be discarded in an air stream. The function of the resistive dissipating grid is to discard excess electrical energy generated during braking when the electrical energy generated by the motor/generator exceeds that which can be stored by the electrical energy storage pack, auxiliary power unit or the optional thermal or flywheel energy storage unit (which itself typically includes a dissipative resistive grid to convert electrical energy into heat energy).

This electrical circuit provides several control capabilities to the gas turbine engine shown in FIG. 15, many of which are utilized to maintain high engine efficiency over a broad range of engine power output. The circuit of FIG. 15 is meant to be general and does not show all the components necessary to control voltages and currents. The control capabilities of FIG. 15 include:
starting the engine;
providing a momentary power boost when required;
providing engine braking when needed;
providing over-speed protection for the free power turbine 5 when load 6 is rapidly reduced or disconnected;
charging the energy storage system;
providing auxiliary power;
controlling the responsiveness of the engine under changing load and/or ambient air conditions;
restoring the compressors and/or turbines toward the operating line when surge or choking limits are approached;
assisting the engine shut-down cycle;
controlling the turbine inlet temperatures by extracting power during power-down; and
controlling the recuperator hot side temperature by extracting power during power-down.

Adding or extracting power by any or all of the turbo-compressor spools will modify the speed of the spool for which power is being added/extracted. This, in turn, will modify flow properties at first locally through the spool compressor and turbine in which power is being added/extracted and then as disturbances propagate through the engine, the overall mass flow in the engine will tend to equilibrate to a new state. It is understood that adding or extracting power by any one of the turbo-compressor spools will result in a new engine state in which the average mass flow and working gas flow power through the engine may be slightly increased or decreased. This is a fine tuning of the flow compared to other means of changing mass flow rate and working gas flow power through the engine such as changing the fuel flow rate (to any or all of the combustors and reheaters) or changing the variable area nozzle setting or both. It is understood that changing turbo-compressor spool speed, changing fuel flow rate, changing VAN setting and changes in ambient conditions will perturb local flow conditions and any disturbances will propagate through the engine and eventually die down so that the mass flow and working gas flow power through the engine achieve substantially steady state values.

### Starting the Engine

The engine of FIGS. 10,11 and 12 may be started by a motor spinning-up the high-pressure turbine only for example if the engine is still hot from having been used recently. The engine may be started by motors spinning-up the high-pressure and medium pressure turbines or by spinning up all three turbines if the engine is cold from having been sitting for an extended period and its components cooled to near ambient.

For example, to start the engine, switch 73 may be closed and switches 70, 71 and 72 may be opened. Energy storage unit 88 provides the power to motor/generator 26 between turbine 69 and compressor 60. Once the high pressure spool is supplied with power, air flow within the cycle occurs, enabling the fuel to be admitted into combustor 41 and the subsequent initiation of combustion. Hot pressurized gas from the high pressure turbine 69 may optionally be further energized by first reheater 31 and then delivered to the intermediate turbine 42. Hot pressurized gas from the intermediate turbine 42 may optionally be further energized by second reheater 32 and then delivered to the low pressure turbine 11. The output of low pressure turbine 11 is then directed to free turbine 5.

Alternately, switches 72 and 73 are closed and switches 71 and 70 are opened. Energy storage unit 88 provides power to motor/generator 26 between turbine 69 and compressor 60 and to motor/generator 27 between turbine 22 and compressor 42. Once the high pressure and intermediate pressure spools are supplied with power, air flow within the cycle occurs, enabling the fuel to be admitted into combustor 41 and the subsequent initiation of combustion. Hot pressurized gas from the high, intermediate and low pressure spools is delivered to the free turbine spool.

If needed, switches 71, 72 and 73 are closed and switch 70 is opened. Energy storage unit 88 provides power to motor/generator 26 between turbine 69 and compressor 60, to motor/generator 27 between turbine 22 and compressor 42 and to motor/generator 28 between turbine 45 and compressor 11. Once the high pressure, intermediate pressure and low pressure spools are supplied with power, air flow within the cycle occurs, enabling the fuel to be admitted into combustor 41 and the subsequent initiation of combustion. Hot pressurized gas from the high, intermediate and low pressure spools is delivered to the free turbine spool.

Optionally, the energy storage unit 88 can also provide power to heat the thermal energy storage unit (not shown) which can preheat the air or fuel-air flow entering combustor 41 until sufficient heat transfer is established through recuperator 44.

### Power Boost

To provide a momentary power boost while the engine is operating, switches 71, 72 and 73 are closed and switch 70 is opened. Energy storage unit 88 provides additional power to motor/generators 26, 27 and 28 which add power to high pressure compressor 60, intermediate compressor 22 and low pressure compressor 45, increasing the working gas flow power throughout the system. As can be appreciated the number of generators used for a power boost can be one, two or three, depending on the level of power boost desired.

### Engine Braking

Another means of providing engine braking (analogous to a Jake brake in a reciprocating engine) is to close switches 71, 72 and 73 while leaving switch 70 open. Motor/generators 26, 27 and 28 then extract small amounts of power (for example, each less than about 10% of the full power rating of the engine) and provide a means of controlling the speed of compressors 45, 22 and 60 by reducing the mass flow through the engine which, in turn, tends to reduce the speed of free power turbine 5. The extracted power can be used to charge energy storage battery 88 and/or heat up a thermal storage unit (not shown) or discarded. As can be appreciated, simultaneously reducing fuel consumption with the variable area turbine nozzle and extracting power using the motor/alternator, the free power turbine 5 will slow down and apply a braking force to the transmission.

### Over-Speed Protection

To provide over-speed protection for the free power turbine 5 when load 6 is rapidly lowered or disconnected, switches 71, 72 and 73 are closed and switch 70 is opened. Motor/generators 26, 27 and 28 then extract a small amount of power that provides a means of controlling the speed of compressors 60, 22 and 45 by reducing the mass flow through the engine which, in turn, tends to reduce the speed of free power turbine 5. As can be appreciated, when load 6 is rapidly lowered or disconnected, variable vane turbine nozzle 40 can provide additional control by further controlling the rate of flow of air to the turbine 5. The power extracted by motor/generators 26, 27 and 28 can be used to charge electrical energy storage apparatus 88. As can be appreciated, one, two or three motor/generators 26, 27 and 28 can be used to extract power to provide over-speed protection for the free power turbine 5.

### Charging the Energy Storage System

To charge energy storage system 88 during vehicle braking, switch 70 is closed and switches 71, 72 and 73 are opened and a hybrid transmission as part of load 6, in motoring mode, can be used to transfer some or all of the energy of braking to energy storage system 88. Although not shown, a dynamic braking grid located elsewhere on the vehicle may be switched in and used to dissipate braking energy from a hybrid transmission which can be discarded by air flow past the vehicle. Other means of utilizing and/or dissipating energy of braking are disclosed in U.S. patent application Ser. No. 13/210,121 entitled “Gas Turbine Engine Braking Method” filed Aug. 15, 2011, which is incorporated herein by reference.

### Providing Auxiliary Power

Although the connection to an auxiliary power system not shown in FIG. 15, the energy storage system, any or all of the motor/generators 26,27 and 28 in power extraction mode or any combination of these systems may be used to provide auxiliary power as needed, either continuously or intermittently.

### Controlling Engine Responsiveness

Motor/generators 26, 27 and 28 may be used to exert control over the responsiveness of the engine by adding or extracting energy from their respective compressors. When a small amount of energy is added by one or more of the motor/generators, the local mass flow through the corresponding compressor may be slightly increased. When a small amount of energy is extracted by one or more of the motor/generators, the local mass flow through the corresponding compressor may be slightly decreased. This procedure can fine tune mass flow whereas the variable area nozzle makes coarser adjustments to mass flow since it typically has discrete settings.

The variable vane turbine nozzle 40 may be included in the engines shown in FIGS. 10, 11 and 12. Although the gas turbine embodiments herein may operate with a conventional fixed geometry turbine nozzle, the use of a variable vane turbine nozzle 40 is advantageous in that it enables an additional control feature to lower fuel consumption by controlling the rate of flow of air and/or the aerodynamic characteristics of the air to the turbine 5 of the free turbine spool. The ability to lower fuel consumption makes the present development more efficient. Such a variable vane nozzle is prior art and is described for example in U.S. Pat. No. 7,393,179 entitled “Variable Position Turbine Nozzle” which is incorporated herein by reference.

In other situations, one or two of the motor/generators may add energy while the third motor/generator extracts energy. This will cause a transient redistribution of mass flow which can be used to modify the responsiveness of the engine to changes detected in ambient air temperature and density or in response to changing of engine load, such as when the vehicle is accelerating or braking. As can be appreciated, one or two of the motor/generators may extract energy while the third motor/generator adds energy. This will cause a transient redistribution of mass flow and working gas flow power which can be used to modify the responsiveness of the engine in a different way from that described previously. As can be appreciated, when there is a transient perturbation of mass flow and flow power, there will be an adjustment of compressor speed and pressure ratio whose effects will propagate through the engine until a new quasi-equilibrium state is reached.

The addition or extraction of energy by the motor/generators may be controlled automatically to vary the responsiveness of the engine in response to changes detected in ambient air temperature, density and/or humidity, or in response to changing of engine load, such as when the vehicle is accelerating or braking. The addition or subtraction of power to the spools may also lead to better turbine matching hence increased component efficiency or poor matching hence decreased component efficiency, if engine braking is desired.

Controlling engine responsiveness by adding and extracting small amounts of power at each spool was previously disclosed in U.S. patent application Ser. No. 13/175,564.

### Modifying Compressor and Turbine Operating Points

It is desirous to maintain the high pressure turbine inlet temperature substantially constant at its highest allowable value over most of the power range so as to maintain the highest possible engine efficiency. This can be accomplished by controlling the fuel flow and mass flow in the engine while maintaining an approximately constant or even decreasing fuel-air ratio. These latter steps must be carried out while respecting the operating points on the compressor and turbine maps. Fuel-air ratio may decrease during power-down even as the turbines become less efficient. Flow temperature exiting the free power turbine and entering the hot side of the recuperator increases, thereby increasing the heat transfer to the cold side of the recuperator which, in turn, increases the preheating of the air entering the combustor.

A compressor map is typically a graph showing compressor pressure ratio plotted versus corrected flow mass rate wherein a surge limit curve, a choke limit curve and an selected operating curve are typically shown. The map may also show various curves of constant compressor speed. A companion compressor map may also be a graph showing compressor isentropic efficiency plotted versus corrected flow mass rate and the map may also show various curves of constant compressor speed and the selected operating curve.

A typical turbine map is a graph showing corrected flow mass rate plotted versus turbine pressure ratio in the form of curves of constant speed. A companion turbine map may also be a graph showing isentropic efficiency plotted versus turbine pressure ratio in the form of curves of constant speed.

For turbo-compressor spools as shown herein, compressor speed is typically the same as its counterpart turbine speed. Also the work extracted from the flow by the turbine is equal to the work done by the compressor plus turbo-compressor spool bearing losses. The mass flow rate through the turbine is equal to the mass flow rate through compressor plus the fuel flow rate added in the combustor. As can be appreciated, there may be other forms of compressor and turbine maps.

The compressors and turbines are maintained preferably within the regions between surge and choke. This requires monitoring all compressor and turbine speeds, all compressor pressure ratios and turbine inlet temperatures, and making constant reference to the compressor and turbine maps. Changes to the fuel-air ratio in the combustor are typically used to compensate for variances in the compressor and turbine efficiencies and in the recuperator effectiveness, all of which are functions of mass flow.

If an operating point on a compressor approaches either its surge line or choking limit, then adding and extracting small amounts of power at any or all of the turbo-compressor spools can be used to move the operating point away from either of these limits.

### Engine Power-Down and Shutdown

As a gas turbine engine is powered down, primarily by reducing mass flow at an approximately constant or decreasing fuel-air ratio, the temperature drop through the high-pressure turbine is reduced because the high-pressure compressor is doing less work. Therefore, the low and medium pressure turbine inlet temperatures increase, in some instances, beyond a threshold where the metallic turbine blades can over-heat, deforming, melting or even failing. The low and medium pressure turbine inlet temperatures increase in this way when the high pressure turbine inlet temperature is maintained substantially constant at or near its full power level. The primary way to prevent the lower pressure turbines from over-heating comprises reducing the fuel-air ratio to reduce high pressure turbine inlet temperature. As will be appreciated by one of skill in the art, reducing the high pressure turbine inlet temperature reduces the net thermal efficiency of the engine.

By extracting power from the high-pressure spool during power-down, the high-pressure turbine continues to output work at near-normal levels and, thus, the temperature drop through the high-pressure turbine is maintained. That is, the high-pressure turbine inlet temperature can be maintained substantially at or near its maximum design value longer and engine efficiency is maintained by extracting power from the high-pressure spool. By reducing fuel consumption with the variable area turbine nozzle and extracting power using the motor/alternator on at least the high-pressure spool, the lower pressure turbine inlet temperatures can be significantly reduced and/or maintained below predetermined thresholds while the high-pressure turbine inlet temperature is maintained at about its highest allowable operating level.

The gas flow in a modern gas turbine engine can be computed by assuming the inlet air and combustion products behave as ideal gases in which enthalpies and constant pressure heat capacities are functions only of temperature. This means that the combustor output temperature is, to a first order, dependent only on fuel-air ratio and is, for practical purposes, not sensitive to combustor pressure. During power-down, the heat transfer through the recuperator varies because of thermal inertia and the temperature increase in the flow through the hot side of the recuperator. Therefore, fuel flow can be a useful control parameter and maintaining an approximately constant or slowly decreasing fuel-air ratio can be important to maintaining an approximately constant high pressure turbine inlet temperature.

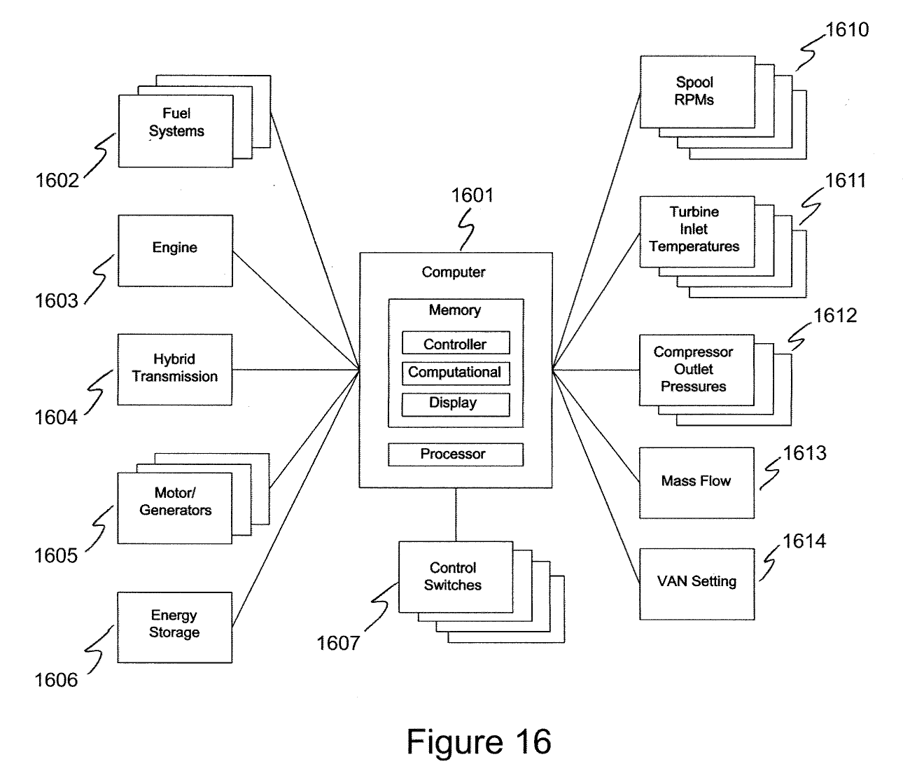

FIG. 16 shows an example of a possible computer control system for a multi-spool engine with two stages of intercooling and reheat. The engine is monitored and controlled by a computer 1601 which is comprised of a processor and memory. The memory is further comprised of a controller module, a computational module and a display module. Computer 1601 receives operating information from spool rpms 1610, turbine inlet temperatures 1611, compressor outlet pressures 1612, mass flow sensors 1613, variable area nozzle settings 1614, energy storage systems 1601, motor/generators 1605, transmission 1604, engine 1603, fuel systems 1602 and control switches 1607. Based on various control algorithms in the computer memory, computer 1601 issues control commands to control switches 1607, fuel systems 1602, variable area nozzle 1614, energy storage systems 1601, motor/generators 1605, and transmission 1604.

Spool rpms 1610 include readings of all spool speeds, which for the multi-spool engine of FIG. 10 are the three turbo-compressor spools and the free power turbine spool. Turbine inlet temperatures 1611 include turbine inlet temperatures, which for the multi-spool engine of FIG. 10 pertain to the three turbo-compressor turbines and the free power turbine. Compressor outlet pressures 1612 include compressor outlet pressures, which for the multi-spool engine of FIG. 10 pertain to the three turbo-compressor compressors. Mass flow sensor 1613 includes a mass flow of the inlet air. Mass flow downstream of the combustors and reheaters may be calculated from fuel mass flow sensors for each combustor apparatus. Variable area nozzle settings 1614 are defined as the fraction of full nozzle setting for the VAN preferably located just upstream of free power turbine inlet for the engine of FIG. 10. Energy storage systems 1601 information includes state-of-charge information, voltage and on/off status for an example of a battery pack energy storage system. Motor/generators 1605 information includes voltage, current and on/off status for an example. Transmission 1604 information includes gear ratio settings, motoring or generating current, status of dynamic dissipating grid (if used). Engine 1603 includes power output shaft speed, output torque and power. Fuel systems 1602 information includes fuel type (if a multi-fuel engine), fuel consumption rate and fuel temperature. Control switches 1607 information would include on/off status.

Computer 1601 controls the fuel flow rate to the fuel systems 1602 for the main combustor and reheaters, hybrid transmission settings 1604, motor/generator 1605 state (motoring, generating or free-wheeling) as well as amount of power extracted or added, energy storage system 1606 state (discharging, charging or off), variable are nozzle setting 1614 and control switch settings 1607 (on or off). Control of the fuel flow rate to the fuel systems 1602 includes increasing and decreasing fuel flow rates to control the inlet temperature of the turbines downstream of the combustor or reheater being controlled. Control of hybrid transmission settings 1604 includes changing gear ratios as required, switching the hybrid transmission between motoring and generating. Control of the motor/generator 1605 states includes managing engine responsiveness, braking, free power turbine over-speed and turbine inlet temperatures by determining mode (motoring, generating or free-wheeling) and the amount of power extracted or added by each motor/generator. Control of the energy storage system 1606 state includes starting the engine, charging the battery, providing power to the motor/alternators as needed for engine responsiveness, braking, free power turbine over-speed and turbine inlet temperature control, and discarded braking energy using a dynamic braking grid if available. Control of the variable are nozzle 1614 includes setting the variable are nozzle angle to control mass flow rate for powering-up, powering down, braking and free power turbine over-speed control.

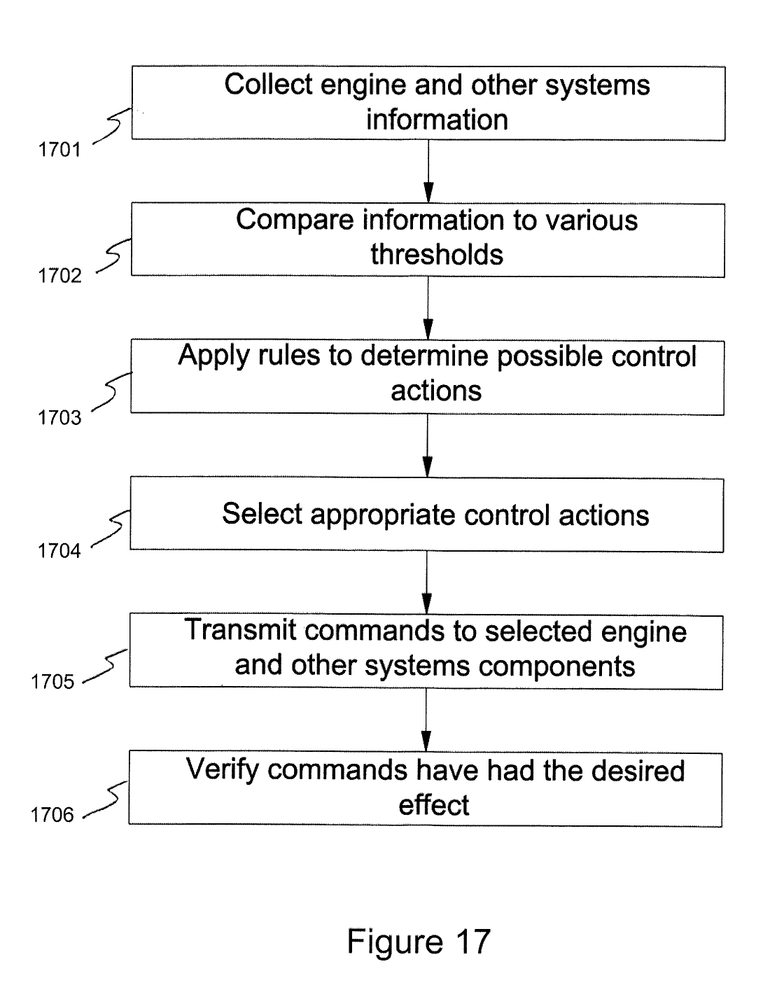

FIG. 17 is a flow chart illustrating an operational embodiment of the system of FIG. 16. In step 1701, the computer interrogates all the active sensors. These include for example, ambient pressure/temperature/humidity, spool rpms, turbine inlet temperatures, compressor outlet pressures, mass flow rate, variable area nozzle settings, energy storage systems state of charge etc, motor/generators status, transmission status, fuel flow rates and status of control switches. As can be appreciated, some of this information can be calculated from other measurements rather than measured. For example compressor outlet pressures can be calculated from a knowledge of mass flow, spool rpms and compressor maps. In step 1702, the collected information is used to determine if selected thresholds have been exceeded. Threshold include, for example, compressor surge and choke boundaries and not-to-exceed turbine inlet temperatures. In step 1703, the computer applies predetermined rules to determine control actions to change flow variables, switch settings and the like to avoid the engine moving into undesired states and for components to exceed design thresholds. For example, each compressor may have a spool speed and pressure ratio relationship to keep the compressor operating point from passing a selected point relative to its surge line. In step 1704, appropriate control actions are selected. Examples of these include adding or extracting power by one or more spools using the motor/generators, selecting a different variable are nozzle (“VAN”) setting, and changing a fuel rate to the main combustor or one of the reheaters. In step 1705, the selected control actions are transmitted to the engine, transmission, braking system and/or energy storage system. Finally, in step 1706, the computer interrogates all the active sensors again and verifies that the responses to the commands are having the desired effect. For example, during power-down, the turbine inlet temperatures of the intermediate pressure, low pressure and free power turbines should remain a predetermined amount below their threshold design values as fuel flow rates, VAN settings and power extraction are adjusted according to step 1704.

The operations required of a vehicle, for example, are in part initiated by operator requests. In addition, many of the operations are preferably carried out automatically under computer control.

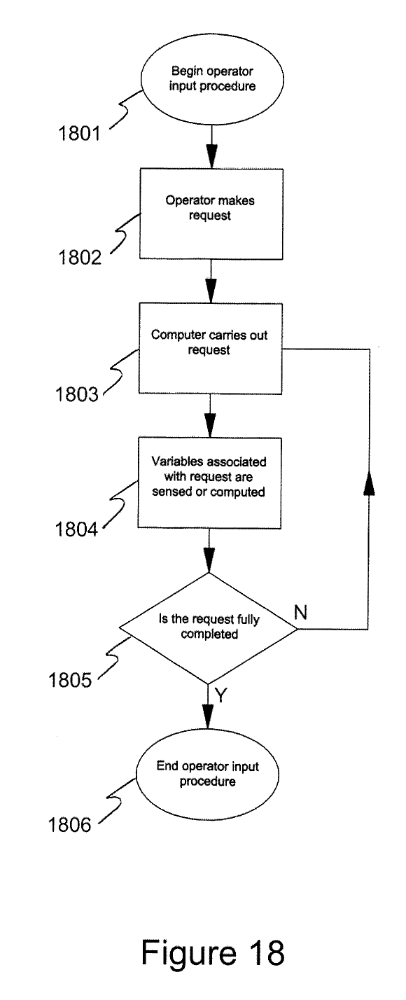

FIG. 18 is a flow chart illustrating operator inputs to a computer controlled engine. Operator inputs for a vehicle include but are not limited to starting the engine, changing engine speed, requesting a power boost, braking, changing gears and controlling auxiliary power. An operator requests begins 1801 when an operator makes a request 1802. This request is transmitted to the vehicle's control computer to carry out the request 1803. The computer senses the current engine state and variables associated with carrying out the request 1804. As described previously, some of the variables required may be computed from sensed variables, for example, using compressor and turbine maps stored in the computer's memory. If the operator's request is completed 1805 then the operator input procedure is terminated 1806. If the operator's request is not completed 1805 then the computer loops back through the request procedure 1803 until the procedure is completed.

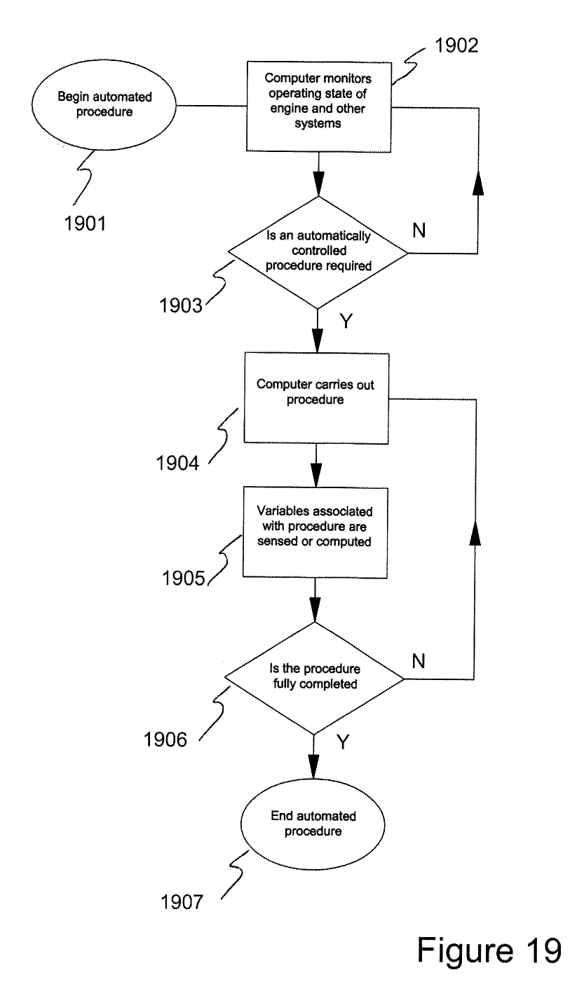

FIG. 19 is a flow chart illustrating automated procedures by a computer controlled engine. As described above, the vehicle's control computer carries out all operator requests. In addition, the vehicle's control computer automatically controls a number of other engine, energy storage and transmission responses. These include but are not limited to free turbine over-speed control, charging and maintaining the energy storage system, controlling engine responsiveness to changes in ambient conditions, changing of gears and vehicle speed, changes in engine power, maintaining the compressors and turbines within their desired operating regions of their compressor and turbine maps, and engine shut-down control of turbine inlet and recuperator temperatures. An automated procedure begins 1901 with the vehicle's control computer monitoring the various automated procedures 1902. If an automated procedure is not required 1903, the computer continues to monitor 1902. If an automated procedure is required 1903, the computer then carries out the required procedure 1904. The computer senses the variables associated with the procedure 1905. As described previously, some of the variables required may be computed from sensed variables, for example, using compressor and turbine maps stored in the computer memory. If the procedure is completed 1906 then the automated procedure is terminated 1907. If the procedure is not completed 1805 then the computer loops back through to the start of the procedure 1904 until the procedure is completed.

FIGS. 18 and 19 are applicable to a vehicle engine. For application to power generation such as for gas compression, distributed power and the like, most of the engine's functions will be controlled automatically in much the same way as a vehicle engine but there will be typically less operator inputs.

The disclosure has been described with reference to the preferred embodiments. Modifications and alterations will occur to others upon a reading and understanding of the preceding detailed description. It is intended that the disclosure be construed as including all such modifications and alterations insofar as they come within the scope of the appended claims or the equivalents thereof.

A number of variations and modifications of the disclosures can be used. As will be appreciated, it would be possible to provide for some features of the disclosures without providing others.

The present disclosure, in various embodiments, includes components, methods, processes, systems and/or apparatus substantially as depicted and described herein, including various embodiments, sub-combinations, and subsets thereof. Those of skill in the art will understand how to make and use the present disclosure after understanding the present disclosure. The present disclosure, in various embodiments, includes providing devices and processes in the absence of items not depicted and/or described herein or in various embodiments hereof, including in the absence of such items as may have been used in previous devices or processes, for example for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments for the purpose of streamlining the disclosure. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the disclosure.

Moreover though the description of the disclosure has included description of one or more embodiments and certain variations and modifications, other variations and modifications are within the scope of the disclosure, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. An engine, comprising:
a higher pressure spool having a higher pressure compressor and a higher pressure turbine;
an intermediate pressure spool having an intermediate pressure compressor and an intermediate pressure turbine;
a lower pressure spool having a lower pressure compressor and a lower pressure turbine;
wherein at least one of the following is true:
(i) first and second intercoolers are positioned respectively between the lower and intermediate pressure compressors and the intermediate and higher pressure compressors, whereby the first intercooler removes thermal energy from a first compressor output of the lower pressure compressor and the second intercooler removes thermal energy from a second compressor output of the intermediate pressure compressor; and
(ii) first and second thermal reactors are positioned respectively between the higher and intermediate pressure turbines and the intermediate and lower pressure turbines, whereby the first thermal reactor adds thermal energy to a first turbine output of the higher pressure turbine and the second thermal reactor adds thermal energy to a second turbine output of the intermediate pressure turbine.

2. The engine of claim 1, wherein (i) is true.

3. The engine of claim 2, further comprising a free power turbine connected to a load.

4. The engine of claim 2, wherein the lower pressure turbine is connected directly to a load.

5. The engine of claim 1, wherein (ii) is true.

6. The engine of claim 5, further comprising a combustor comprising a nearly isobaric, deflagrating combustion zone and wherein the first and second thermal reactors each comprise a nearly-isobaric, continuous oxidization zones.

7. The engine of claim 5, wherein the combustor is a dry low NOX combustor, wherein the first and second thermal reactors are thermal oxidizers, and wherein the engine operates at a pressure ratio that ranges from about 1.5 to about 2.5 times an optimum pressure ratio for the engine at a selected engine power level.

8. The engine of claim 1, further comprising a combustor and at least one of a recuperator, a regenerator and a variable area nozzle.

9. The engine of claim 1, wherein a first rotatable shaft rotatably couples the higher pressure compressor and the higher pressure turbine, wherein a second shaft rotatably couples the intermediate pressure compressor and intermediate pressure turbine, wherein a third shaft rotatably couples the lower pressure compressor and lower pressure turbine, and wherein at least two of the first, second, and third rotatable shafts are in mechanical communication with one or both of a motor and generator.

10. A method, comprising:
compressing, by a lower pressure compressor, a working fluid to form a lower pressure compressor working fluid;
compressing, by an intermediate pressure compressor, the lower pressure compressor working fluid to form an intermediate pressure compressor working fluid, an operating pressure of the lower pressure compressor working fluid being less than an operating pressure of the intermediate pressure compressor working fluid;
compressing, by a higher pressure compressor, the intermediate pressure compressor working fluid to form a higher pressure compressor working fluid, an operating pressure of the intermediate pressure compressor working fluid being less than an operating pressure of the higher pressure compressor working fluid;
combusting, by a combustor, the third working fluid in the presence of a fuel to form a combustor output;
operating, by the combustor output, a higher pressure turbine to form a higher pressure turbine output;
operating, by the higher pressure turbine output, an intermediate pressure turbine to form an intermediate pressure turbine output; and
operating, by the intermediate pressure turbine output, a lower pressure turbine to form an engine output;
wherein at least one of the following is true:
(i) first and second intercoolers are positioned respectively between the lower and intermediate pressure compressors and the intermediate and higher pressure compressors, whereby the first intercooler removes thermal energy from lower pressure compressor output and the second intercooler removes thermal energy from the intermediate compressor output; and
(ii) first and second thermal reactors are positioned respectively between the higher and intermediate pressure turbines and the intermediate and lower pressure turbines, whereby the first thermal reactor adds thermal energy to higher pressure turbine output and the second thermal reactor adds thermal energy to the intermediate pressure turbine output.

11. The method of claim 10, wherein (i) is true.

12. The method of claim 11, further comprising a free power turbine connected to a load.

13. The method of claim 11, wherein the lower pressure turbine is connected directly to a load.

14. The method of claim 10, wherein (ii) is true.

15. The method of claim 14, further comprising a combustor comprising a nearly isobaric, deflagrating combustion zone and wherein the first and second thermal reactors each comprise a nearly isobaric, continuous oxidization zones.

16. The method of claim 14, wherein the combustor is a dry low NOX combustor, wherein the first and second thermal reactors are thermal oxidizers, and wherein the engine operates at a pressure ratio that ranges from about 1.5 to about 2.5 times an optimum pressure ratio for the engine at a selected engine power level

17. The method of claim 10, further comprising a combustor and at least one of a recuperator, a regenerator and a variable area nozzle.

18. The method of claim 10, wherein a first rotatable shaft rotatably couples the higher pressure compressor and the higher pressure turbine, wherein a second shaft rotatably couples the intermediate pressure compressor and intermediate pressure turbine, wherein a third shaft rotatably couples the lower pressure compressor and lower pressure turbine, and wherein at least two of the first, second, and third rotatable shafts are in mechanical communication with one or both of a motor and generator.

19. An engine, comprising:
a higher pressure spool having a higher pressure compressor, a higher pressure turbine, and a first rotatable shaft rotatably couples the higher pressure compressor and the higher pressure turbine;
an intermediate pressure spool having an intermediate pressure compressor, an intermediate pressure turbine, and a second shaft rotatably couples the intermediate pressure compressor and intermediate pressure turbine;
a lower pressure spool having a lower pressure compressor, a lower pressure turbine, and a third shaft rotatably couples the lower pressure compressor and lower pressure turbine;
wherein at least two of the higher, intermediate, and lower pressure spools are in mechanical communication with one or both of a motor/generator device; and
wherein at least one of the following is true:
(i) first and second intercoolers are positioned respectively between the lower and intermediate pressure compressors and the intermediate and higher pressure compressors, whereby the first intercooler removes thermal energy from a first compressor output of the lower pressure compressor and the second intercooler removes thermal energy from a second compressor output of the intermediate pressure compressor; and
(ii) first and second thermal reactors are positioned respectively between the higher and intermediate pressure turbines and the intermediate and lower pressure turbines, whereby the first thermal reactor adds thermal energy to a first turbine output of the higher pressure turbine and the second thermal reactor adds thermal energy to a second turbine output of the intermediate pressure turbine.

20. The engine of claim 19, wherein (i) is true.

21. The engine of claim 19, wherein (ii) is true.

22. The engine of claim 19, wherein, in a starting mode, electrical energy is applied to the one or both of a motor/generator device on the at least two of the first, second, and third rotatable shafts, thereby rotating the respective one of the first, second, and third rotatable shafts, causing air flow to occur and enabling fuel to be admitted into a combustor.

23. The engine of claim 19, wherein, in a power boost mode, electrical energy is applied, during engine operation, to the one or both of a motor/generator device on the at least two of the first, second, and third rotatable shafts, thereby increasing working gas flow power through the engine.

24. The engine of claim 19, wherein, in an engine braking mode, electrical energy is extracted, during engine operation, to the one or both of a motor/generator device on the at least two of the first, second, and third rotatable shafts, thereby decreasing working gas flow power through the engine.

25. The engine of claim 19, wherein, in an over-speed protection mode, electrical energy is extracted, during engine operation, to the one or both of a motor/generator device on the at least two of the first, second, and third rotatable shafts, thereby decreasing working gas flow power through the engine and reducing a rotational speed of a free power turbine connected to a load.

26. The engine of claim 19, wherein, in an energy storage system charging mode, electrical energy is extracted, during engine operation, to the one or both of a motor/generator device on the at least two of the first, second, and third rotatable shafts, and used to charge an electrical energy storage system.

27. The engine of claim 19, wherein, in a controlling engine responsiveness mode, a first one of the motor/generator device extracts electrical energy from the engine while a second one of the motor/generator device adds electrical energy to the engine, thereby causing a redistribution of working gas flow power, whereby a responsiveness of the engine is controlled.

28. The engine of claim 19, further comprising a computer readable medium comprising microprocessor executable instructions that, when executed, vary a responsiveness of the engine in response to changes detected in at least one of ambient air temperature, ambient air density, fuel consumption rate, variable area nozzle setting, engine load, and ambient air humidity.

29. The engine of claim 19, further comprising a computer readable medium comprising microprocessor executable instructions that, when executed, maintains a higher pressure turbine inlet temperature substantially constant by controlling at least one of a fuel flow, a working gas flow power and a mass flow of the engine while maintaining a substantially constant or decreasing fuel-air mixture ratio.

30. The engine of claim 29, wherein the microprocessor, when executing the instructions, bases an engine operation command on one or more operating parameters of the engine relative to at least one of a compressor and turbine map.

31. The engine of claim 30, wherein the one or more operating parameters comprise one or more of compressor rpm, turbine rpm, compressor pressure ratio, turbine pressure ratio, turbine inlet temperature, and mass flow rate through the engine and wherein each of the lower, intermediate, and higher pressure compressors are maintained in an operating region between surge and choke.

32. The engine of claim 19, wherein, in an engine power-down and/or shutdown mode, at least one of a motor/generator device in mechanical communication with the first rotatable shaft extracts power from the higher pressure spool, such that the higher pressure turbine inlet temperature is maintained at or near its maximum desired value, thereby maintaining a selected temperature drop through the higher pressure turbine.

33. A method, comprising:
providing:
a higher pressure spool having a higher pressure compressor, a higher pressure turbine, and a first rotatable shaft rotatably couples the higher pressure compressor and the higher pressure turbine;
an intermediate pressure spool having an intermediate pressure compressor, an intermediate pressure turbine, and a second shaft rotatably couples the intermediate pressure compressor and intermediate pressure turbine;
a lower pressure spool having a lower pressure compressor, a lower pressure turbine, and a third shaft rotatably couples the lower pressure compressor and lower pressure turbine;
wherein at least two of the higher, intermediate, and lower pressure spools are in mechanical communication with one or both of a motor/generator device;
compressing, by the lower pressure compressor, a working fluid to form a lower pressure compressor working fluid;
compressing, by the intermediate pressure compressor, the lower pressure compressor working fluid to form an intermediate pressure compressor working fluid, an operating pressure of the lower pressure compressor working fluid being less than an operating pressure of the intermediate pressure compressor working fluid;
compressing, by the higher pressure compressor, the intermediate pressure compressor working fluid to form a higher pressure compressor working fluid, an operating pressure of the intermediate pressure compressor working fluid being less than an operating pressure of the higher pressure compressor working fluid;
combusting, by a combustor, the third working fluid in the presence of a fuel to form a combustor output;
operating, by the combustor output, the higher pressure turbine to form a higher pressure turbine output;
operating, by the higher pressure turbine output, the intermediate pressure turbine to form an intermediate pressure turbine output; and
operating, by the intermediate pressure turbine output, the lower pressure turbine to form an engine output;
wherein at least one of the following is true:
(i) first and second intercoolers are positioned respectively between the lower and intermediate pressure compressors and the intermediate and higher pressure compressors, whereby the first intercooler removes thermal energy from lower pressure compressor output and the second intercooler removes thermal energy from the intermediate compressor output; and
(ii) first and second thermal reactors are positioned respectively between the higher and intermediate pressure turbines and the intermediate and lower pressure turbines, whereby the first thermal reactor adds thermal energy to higher pressure turbine output and the second thermal reactor adds thermal energy to the intermediate pressure turbine output.

34. The method of claim 33, wherein (i) is true.

35. The method of claim 33, wherein (ii) is true.

36. The method of claim 33, wherein, in a starting mode, electrical energy is applied to the one or both of a motor/generator device on the at least two of the first, second, and third rotatable shafts, thereby rotating the respective one of the first, second, and third rotatable shafts, causing air flow to occur and enabling fuel to be admitted into a combustor.

37. The method of claim 33, wherein, in a power boost mode, electrical energy is applied, during engine operation, to the one or both of a motor/generator device on the at least two of the first, second, and third rotatable shafts, thereby increasing working gas flow power through the engine.

38. The method of claim 33, wherein, in an engine braking mode, electrical energy is extracted, during engine operation, to the one or both of a motor/generator device on the at least two of the first, second, and third rotatable shafts, thereby decreasing working gas flow power through the engine.

39. The method of claim 33, wherein, in an over-speed protection mode, electrical energy is extracted, during engine operation, to the one or both of a motor/generator device on the at least two of the first, second, and third rotatable shafts, thereby decreasing working gas flow power through the engine and reducing a rotational speed of a free power turbine connected to a load.

40. The method of claim 33, wherein, in an energy storage system charging mode, electrical energy is extracted, during engine operation, to the one or both of a motor/generator device on the at least two of the first, second, and third rotatable shafts, and used to charge an electrical energy storage system.

41. The method of claim 33, wherein, in a controlling engine responsiveness mode, a first one of the motor/generator device extracts electrical energy from the engine while a second one of the motor/generator device adds electrical energy to the engine, thereby causing a redistribution of working gas flow power, whereby a responsiveness of the engine is controlled.

42. The method of claim 33, further comprising a computer readable medium comprising microprocessor executable instructions that, when executed, vary a responsiveness of the engine in response to changes detected in at least one of ambient air temperature, ambient air density, fuel consumption rate, variable area nozzle setting, engine load, and ambient air humidity.

43. The method of claim 33, further comprising a computer readable medium comprising microprocessor executable instructions that, when executed, maintains a higher pressure turbine inlet temperature substantially constant by controlling at least one of a fuel flow and mass flow of the engine while maintaining a substantially constant or decreasing fuel-air mixture ratio.

44. The method of claim 43, wherein the microprocessor, when executing the instructions, bases an engine operation command on one or more operating parameters of the engine relative to at least one of a compressor and turbine map.

45. The method of claim 44, wherein the one or more operating parameters comprise one or more of compressor rpm, turbine rpm, compressor pressure ratio, turbine pressure ratio, higher pressure turbine inlet temperature, and mass flow rate through the engine and wherein each of the lower, intermediate, and higher pressure compressors are maintained in an operating region between surge and choke.

46. The method of claim 33, wherein, in an engine power-down and/or shutdown mode, at least one of a motor/generator device in mechanical communication with the first rotatable shaft extracts power from the higher pressure spool, such that the higher pressure turbine continues to work at near-normal or at an increased level, thereby maintaining a selected temperature drop through the higher pressure turbine.

47. A computer readable medium comprising microprocessor executable instructions that, when executed, cause the performance of the compressing, combusting and operating steps of claim 33.
